(19) United States
(12) Patent Application Publication
(10) Pub. No.: US 2002/0173971 A1
(43) Pub. Date: Nov. 21, 2002

(54) System, method and application of ontology driven inferencing-based personalization systems

(76) Inventors: Paul Alan Stirpe, Shoreham, NY (US); Michael Antico, Northport, NY (US); William John Pinfold, Northport, NY (US); Tim Slavin, Wilton, CT (US)

Correspondence Address: BANNER & WITCOFF, 1001 G STREET N W, SUITE 1100, WASHINGTON, DC, 20001, US

(21) Appl. No.: 09/818,953

(22) Filed: Mar. 28, 2001

(51) Int. Cl. G06F 17/60

(52) U.S. Cl. 705/1

(57) ABSTRACT

The present invention provides a system, method, and applications for providing personalized user experiences based on the use of a core ontology and inferencing over the ontology using rules provided by a domain expert. The population of users may be known to a commerce or information service from external and internal user data sources. Information (data) about this population is brought into a knowledge warehouse designed for on-line analytic processing, and potentially data marts. Data can be sourced from external databases in batch or streaming mode and enhanced with real-time click stream events from internal observed user interactions. A reference ontology is either loaded into the system or defined via a domain expert. The ontology forms the central reference point for data enrichment and precise personalization. Characteristic data is tagged in accordance with direct reference to the nodes of the ontology and may be enhanced via inferencing techniques. This results in enriched and more precise data tagging and equates to discovery of interest domains not directly observed in the initial source data. Definitions of communities can be embedded in the reference ontology thereby allowing the rapid assignment of individuals to collaborative filters or discovered via statistical means using the enriched attributes. Discovery can be fed back into the ontology to add extensions to the ontology. The same reference ontology is used to tag content, which results in a consistent tagging discipline for data and content centered on the reference ontology. Using inference techniques based on the ontology, content may be enriched to discover attributes not explicitly announced in the content descriptions. The enriched data may be mapped to the enriched content resulting in a deeply personalized user experience.

### BACKGROUND OF THE INVENTION

1. Technical Field

The invention relates to a personalization system. More particularly, the invention describes a system, method and applications that provide personalized computer user experiences based on the use of ontologies, extended data and content attributes.

2. Related Information

Service and content providers attempt to provide relevant information to users. In the internet realm, service and content providers add value to the services and content they recommend and provide by personalizing the information to the user. Despite this simple goal, determining what a user needs is difficult to determine without significant user interaction (e.g., prolonged interviews with numerous questions and answers). Basic personalization is provided by many internet web services and is often believed to enhance the user experience or save the user's time in obtaining information, services, products that are highly desirable for the particular user.

The degree of personalization achievable by an internet entity may be separated into various categories. These categories may be defined based on the degree of information provided to the entity from the user. The categories include, but are not limited to: click-stream information; user-defined customization; segmentation; collaborative filtering; and real-time personalization. The click-stream category groups users based on information gathered from monitoring their mouse movements and visited pages when accessing a site. This information builds a picture of an otherwise anonymous user's interests. The user-defined customization category groups users by user-selected information filters and set presentation preferences. For example, a user may set a preference to only display pages relating to medical pages related to treating asthma. The segmentation category groups users based on key facts and provides information to users based on what experts or an expert system suggests should be shown to users sharing the same key facts. For example, if a user in the segmentation category is reviewing web pages related to bicycle parts, the system may suggest athletic apparel to be provided to the user as well. Collaborative filtering groups users by profile and provides information to users based on information previously requested by other users who fit a similar profile. The profile may be based on click-stream information, registration details, legacy data and transactions. Finally, real-time personalization provides specific information to specific users based on known information about each particular user.

While the first four categories are realized on current web sites and with expert systems, real-time personalization has not been achieved. Further, while systems exist that use information about users, these systems require the user to input large amounts of information to increase the level of personalization desired by the user. Moreover, current systems are plagued by inaccurate legacy information. Once some personalization has been added to a user's identity, this personalization information is rarely deleted, if ever. So, if a user Bob was shopping on-line for a present for Jane and Jane liked ferns, Bob would be forever linked to a personalization entry indicating that he liked ferns, even though Bob may personally hate ferns. Bob would eventually stop using the on-line service or content provider because he keeps getting shown information and advertisements about ferns. Accordingly, a system is needed that enables personalization without the detriments of legacy information.

### SUMMARY OF INVENTION

The invention relates to a system, method and applications of an ontology-based personalization system. “Personalization” is referred to as the ability to provide customized information, services or products to users or third parties dealing with users. The customization is tailored to meet the needs and interests of users and can be based on many kinds of information or preferences specified by the user or known about the user.

The invention provides new approaches to providing precise, individual personalization. The system provides real-time personalization first. By means of this high level of personalization, the system also provides other levels of personalization as well. Data from multiple sources is normalized and stored in a data warehouse, but at an individual level. Personalization engines may then access the data and deduce personal interest of each individual user as and when needed. In some embodiments, the personal interest may be recalculated in real time as new data (e.g., click-stream data) becomes available.

One aspect of the invention may be generally referred to as a data warehouse and a content store against an ontology. This aspect of the invention may optionally include at least one inferencing engine that derives inferences between relationships. It may also include information returned from users or third parties back to the data warehouse to increase the amount of user-specific information stored in the data warehouse.

In a second aspect of the invention, it comprises a data warehouse, a content store, an ontology, an domain expert console, and various rules stores. The rules stores may include presentation rules stores and data rules stores. It is appreciated that multiple ontologies may be used. Here, inferencing engines may be used to create inferences or consequences on the ontology, rules and the knowledge warehouse.

Various other aspects of the invention will become known through the following drawings and related description.

### BRIEF DESCRIPTION OF THE DRAWINGS

In the following text and drawings, similar reference numerals denote similar elements. The drawings and text shows various aspects of present invention.

FIG. 1 illustrates the various levels of personalization in accordance with embodiments of the present invention.

FIG. 2 shows a subset of an example ontology personalization in accordance with embodiments of the present invention.

FIG. 3 shows an example structure of an inferencing engine personalization in accordance with embodiments of the present invention.

FIG. 4 shows an example of components of a content management system personalization in accordance with embodiments of the present invention.

FIG. 5 shows a knowledge warehouse with personalization data marts personalization in accordance with embodiments of the present invention.

FIG. 6 shows a sample user's profile personalization in accordance with embodiments of the present invention.

FIG. 7 shows a sample application of a web-based rendering engine personalization in accordance with embodiments of the present invention.

FIG. 8 shows system components personalization in accordance with embodiments of the present invention.

FIG. 9 shows a search engine and indices mapping component in accordance with embodiments of the present invention.

FIG. 10 shows an alternative set of components for the system in accordance with embodiments of the present invention.

FIG. 11 shows an example reference ontology in accordance with embodiments of the present invention.

FIG. 12 shows an example knowledge warehouse table in accordance with embodiments of the present invention.

FIG. 13 shows an example of source user data in accordance with embodiments of the present invention.

FIG. 14 shows sample advertisement content data in accordance with embodiments of the present invention.

FIG. 15 shows news and information stories content in accordance with embodiments of the present invention.

FIG. 16 shows PIG computation interactions in accordance with embodiments of the present invention.

FIG. 17 shows a sample initial working ontology with marked node weights for user pstirpe in accordance with embodiments of the present invention.

FIG. 18 shows a sample PIG results of user pstirpe in accordance with embodiments of the present invention.

FIG. 19 shows a sample click stream information for user pstirpe in accordance with embodiments of the present invention.

FIG. 20 shows a sample click stream knowledge warehouse records for user pstirpe in accordance with embodiments of the present invention.

FIG. 21 shows a sample PIG of user pstirpe, incorporating example click stream activity in accordance with embodiments of the present invention.

FIG. 22 shows a sample initial working ontology with marked node weights for user jdoe in accordance with embodiments of the present invention.

FIG. 23 shows a sample PIG results for user jdoe in accordance with embodiments of the present invention.

FIG. 24 shows explicit data for user jdoe in accordance with embodiments of the present invention.

FIG. 25 shows a sample initial working ontology with marked node weights for user jdoe including explicit data in accordance with embodiments of the present invention.

FIG. 26 shows a sample PIG for user jdoe including explicit characteristic data in accordance with embodiments of the present invention.

FIG. 27 shows a sample reference ontology extended by communities nodes in accordance with embodiments of the present invention.

### DETAILED DESCRIPTION

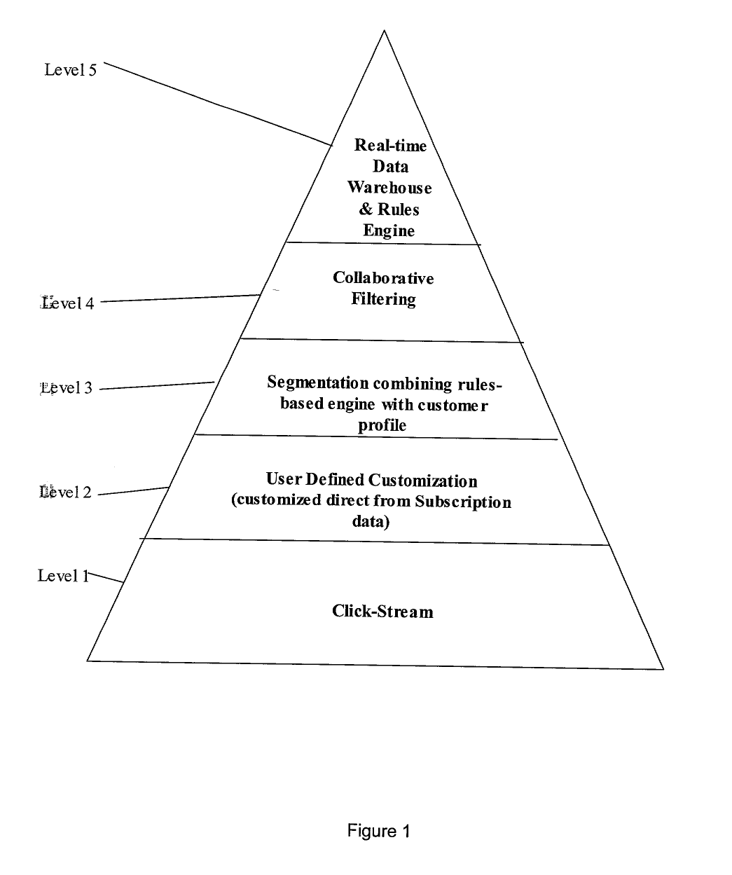

The invention relates to a personalization system, method, and applications. FIG. 1 shows a pyramid with five levels of personalization: level 1 (click-stream personalization), level 2 (user-defined customization—customized directly from subscription data), level 3 (segmentation combining rules-based engine with customer profile), level 4 (collaborative filtering), and level 5 (real-time data using a data warehouse and a rules based engine). At least one of the advantages of the present invention is the combination of a warehouse storing data specific to a user to accomplish level 5 personalization then being able to satisfy the other four levels of personalization based on this information.

The system is described with respect to a number of embodiments. The embodiments contain a variety of components. First, the present system applies personalization from an ontology-centric system perspective. User characteristic data is information describing a user. This information may received from a number or sources including, but not limited to, heath care systems, human resources databases, financial institutions, insurance companies, credit reporting companies, merchant information bases, and the like. This information is mapped against an ontology. Inferences may be generated from the enriched data.

In another embodiment, other (non-user characteristic) content is tagged against the ontology. Rules and at least one inferencing engine run against the ontology to generate inferences of relationships between entries in the ontology as based on at least one of the user characteristic content and the other content, resulting in a higher precision or deeper level of personalization possible. The present system provides inferencing over an ontology where as much of the prior art is typically limited to using click-stream data and explicit data as the input to rules execution.

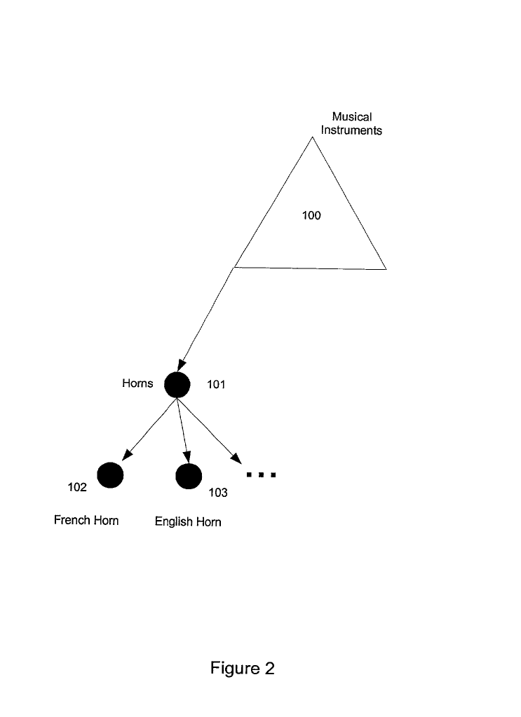

There are potentially millions of ontologies. Ontologies refer to structured representations of knowledge within one or more domains, typically captured and represented in a tree or directed acyclic graph (DAG) format. Vocabularies and taxonomies are often used synonymously with the term ontology. Vocabularies are typically lists of terms. Taxonomies typically define a classification of items. Ontologies represent concepts and the relationship amongst concepts. For example, each node of the ontology may represent a concept, and each link between nodes may represent a relationship, or semantic meaning defined or inherent in the ontology definition. For example, FIG. 2 shows a part of an ontology domain 100 for musical instruments, where the “node” representing horns 101 may have as its children different types of horns 102,103. Disparate ontologies can be combined to produce a single ontology by introducing a parent node. A generalized way of referring to the set of ontologies joined together to produce a single logical ontology that is referenced by the content management system, inferencing engine, and other sub systems of the system, as the “ontology”. The ontology is maintained in a single logical store from which all other subsystems reference or manipulate the ontology.

As an example, a node in the ontology could, but is not limited to, contain the following structural information:

| | |
|---|---|
| Node id: | an ontology wide unique number identifying |
| | the node. |
| Label: | a name of the concept the node represents in the |
| | ontology |
| State: | a multivalued attribute indicating whether the node |
| | is active, deprecated or other such markings. |
| Timestamp: | time at which the node was last edited or altered. |
| Taxonomy source: | source identifier indicating the taxonomy or coding |
| | scheme for which the sub-ontology represents. This |
| | may, for example, be a coding standard. In the |
| | medical diagnosis domain, examples of coding |
| | standards may be ICD9 coding, READ ( ), |
| | SNOMED ( ). |
| Ancestor nodes ids: | list of nodes that point to this node. |
| Predecessor node ids: | list of nodes to which this node points. |

Other representations of ontologies may include less information when not needed or irrelevant or not wanted.

The present system is re-purposeable in that it may utilize entirely distinct ontologies that are from different domains, but the underlying architecture and technology that implements the present system does not require change. Accordingly, one may import a new ontology, tag content against the new ontology, map any provided characteristic data against the ontology, and generate outputs that permit deep personalization for users. In contrast, the prior art personalization systems use ad-hoc rules that do not correspond to a central logical ontology or ontologies or use a very restricted set of concepts that are not well structured.

The present system is also distinct in that it supports inferencing over the content store, such that a content map is created indicating the relationships amongst content, again in support of deeper and more precise user personalization.

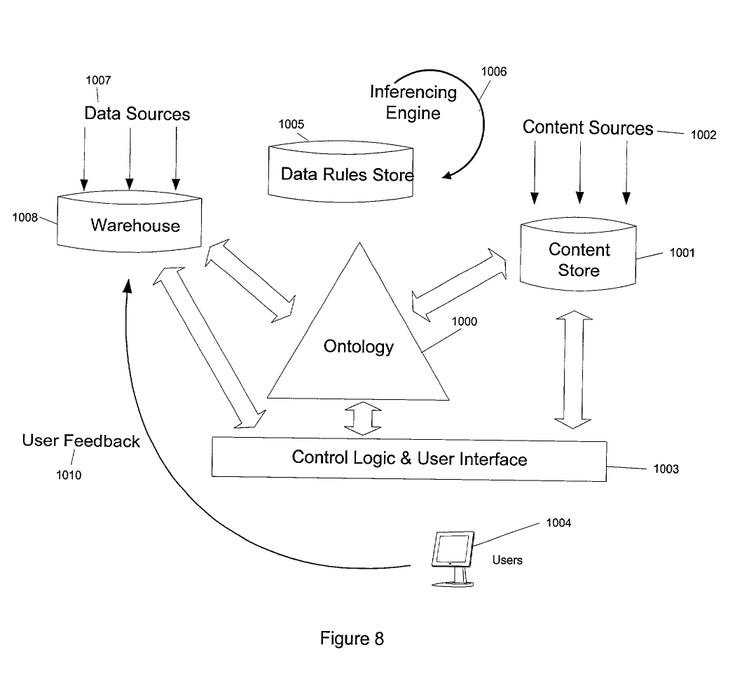

FIG. 8 shows an embodiment that may be used with the present invention. FIG. 8 shows ontology 1000, a data rules storage (or also referred to as a data rules store) 1005 and inferencing engine 1006, and data sources containing user-specific data 1007 (which may be minimal initially and become enriched over time). The enrichment may occur, for example, with click stream data (for example, from monitoring a user's operation of displayed content), source data (for example, from other data stores including healthcare databases, financial databases, human resources databases and the like), explicit data (for example, electronic records of a doctor's office visit), implicit data including previous personalization interest graph (PIG, described below) result sets. The system also includes a warehouse 1008 (also referred to as a knowledge warehouse) that receives and stores information from the user data sources 1007. The system tags content from content sources 1002 (articles, news, and any other non-user specific information) in a content storage (or content store) 1001. The tagging of the content from content sources 1002 is based on the domain space represented by the ontology 1000. The system also includes control logic and a user interface system 1003 that controls the retrieval of information from the warehouse 1008 and from the content store 1001 and its eventual use by users 1004 or persons assisting users. The users may optionally offer feedback 1010 to the warehouse 1008 to improve the degree of precise personalization received from the system.

Users 1004 may receive personalized information in a variety of ways. First, they may be connected to receive the information directly (for example, through a website, through a personal data assistant, through a web-enabled phone, through a web-clipping service and the like). Also, third parties may obtain a user's personalized view and provide this information to yet another party or to the user directly. For example, a healthcare organization may determine that a user may desire certain content. The healthcare provider may obtain this content and provide it to the user. For instance, the user may have seasonal allergies. The healthcare provider may receive information from the system and determine that some content is very relevant to the user. In response, the healthcare provider may provide this information to the user 1004 over the phone, through the mail, through email and any other known way of providing information to the user. Further, the healthcare provider may provide this content to yet another party. This latter party may provide the information to the user in due course or use the content for other purposes, including adjusting the content provided to any of the other levels of FIG. 1.

The present system described above offers information providers a way of personalizing experiences apart from the requirements of user interaction through the extraction of information from the data content sources with mappings to the central ontology to provide deeply personalized experience. The system may use the inferencing engine 1006 and its results to generate new information about what an individual user may like.

The data warehouse 1008 may include specific identities of the users. In an alternative embodiment, the uses may be de-identified. In this alternative embodiment, the system may query a separate database to receive authentication of the user. In response, the system receives a response as to whether or not the user is authenticated. So, even though the user is de-identified in data warehouse 1008, he may still receive personalized information from the system. De-identification is shown in greater detail in U.S. Ser. No. 09/469/02, entitled “ ”, as filed on Dec. 21, 1999, whose contents are incorporated herein by reference.

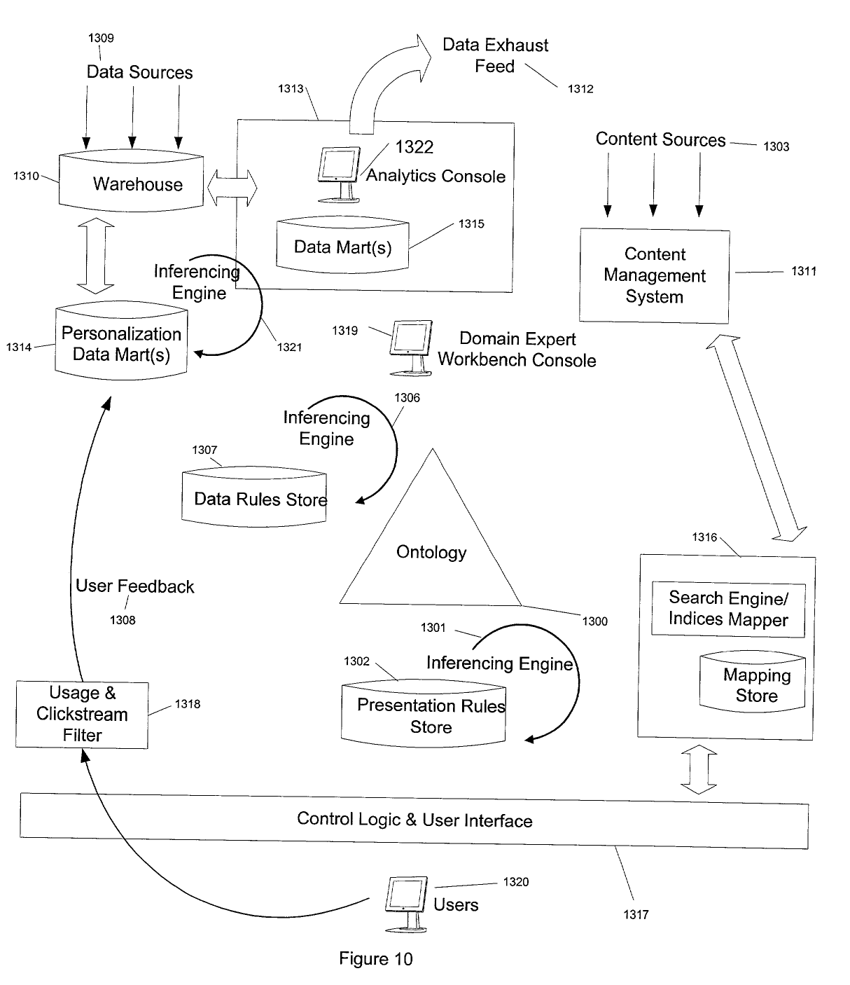

The ontology, which describes relationships amongst concepts, is central to the system. FIG. 10 shows the a personalization system, including data sources (information known a priori about individual users or user identities) stored in a warehouse 1310 (also referred to as a knowledge warehouse), a central reference ontology 1300, a data rules store 1307 and an inferencing engine 1301, 1306, and 1321 that can reason over the user data sources 1309, as well as other input data, to generate new interests or concepts to which the user may be interested. The data rules (stored in data rules store 1307 that are used by the inferencing engine 1306 for reasoning are usually provided by a domain expert. The personal interests output may then be brought to a content store, so as to match the user's interests with content, information or other types of data that may provide a more precise personalization. Finally, the personalized content or information, recommendations, etc. may be rendered to the user in a multitude of ways, often controlled by display (presentation) rules.

FIG. 10 shows an embodiment related to that of FIG. 8 but including additional components. The embodiment shown in FIG. 10 includes a domain expert workbench 1319. The domain expert workbench provides the system with the ability to perform the following (but is not limited to):

1. Interact with the inferencing engine to create, edit, delete rules;

2. Load, edit, deprecate the ontology or a subset of the ontology; and

3. Run ‘what if’ scenarios for testing the results of a given rules base against an ontology and specific user characteristic data.

The system may optionally contain a search engine and indices 1316 component to aid in the quick association of concepts deduced in the PIG with corresponding content contained in the one or more content stores. The search engine and indices component 1316 that includes a search engine/indices mapper and mapping store as is known in the art (see, for example, standard search engine technology including that available from Altavista, Inc.).

The system of FIG. 10 may also contain an inferencing engine 1301 that acts on a presentation rules storage (or store) 1302. These two components provide information for the control logic and user interface 1317 for users or third parties 1320. The presentation rules store 1302 with the inferencing engine 1301 performs the following:

1. Control of the look and feel of the target personalized content eligible to be rendered to the user; and,

2. Deciding what content is to be rendered at what time, to which specific users or third party entities.

Third party entities may use the system to provide personalized information to users without permitting the users to actually access the personalized information. For example, health care organizations may have representatives contact users to advise them of personalized information or new services that are directed specifically at them because of a combination of specific conditions or preferences (liking or disliking chiropractors). The system may optionally contain a mechanism that allows for users to implicitly or explicitly provide feedback 1308 back to the knowledge warehouse regarding their personalization interests. Examples of implicit feedback include clicks-stream and usage data 1308. This implicit feedback may be filtered in a usage and click-stream filter 1318.

The filter provides the option of eliminating irrelevant information or information not related to the ontology 1300.

The system of FIG. 10 provides personalized information as follows. User data from data sources 1309 is loaded into knowledge warehouse 1310. The information stored in knowledge warehouse 1310 is enriched through tagging it with information from ontology 1300. The resulting enriched data is again stored back in the knowledge warehouse 1310. It is appreciated that the enriched user data may be stored in knowledge warehouses separate from knowledge warehouse 1310.

Similar to that shown in FIG. 8, the enriched data in knowledge warehouse 1310 may be forwarded to data marts 1314, 1315. With respect to data mart 1314, it receives information and stores the processing output of inferencing engine 1321. The inferencing engine 1321 reasons over the enriched content and generates new inferred data that may be used to provide new levels of personalization to a user.

With respect to data mart 1315, it is referenced by an analytics console 1322. The analytics console 1322 permits entities to review and try “what if” scenarios to determine if new relationships may exist between information stored in the knowledge warehouse 1310.

Content sources 1303 include non-user specific information from a variety of sources. For example, the sources may include databases of magazines, databases of books or book abstracts, polling information, population statistics, the content available on the internet, and the like. The content from content sources 1303 is stored in the content management system 1311. The information in the content management system may be tagged against ontology 1300. User characteristic data is loaded into the knowledge warehouse 1310. This characteristic data may also be tagged against the ontology 1300. Optionally, personalization data marts 1314 may receive information from the knowledge warehouse 1310. The inferencing engine 1321 may run on the information stored in the personalization data marts 1314 to generate inferred data (propositions). Here, it is appreciated that the inferencing engine 1321 may run on the content of knowledge warehouse 1310 or the personalization data marts 1314 or both. In one embodiment, the inferencing engine may only run on the personalization data marts 1314 to reduce the query loading on the knowledge warehouse and thus improve the performance of the overall system.

It may also be the case that no characteristic data exists in the knowledge warehouse 1310 (and by implication the data marts 1314) when the system is initialized. Characteristic data, if present in the knowledge warehouse 1310, may initially be mapped to correspond nodes in the ontology 1300. Here, the data rules store 1307 contain basic rules to enable the inferencing engine 1321 to operate over the domain space. The rules base should contain relevant rules for the domain space represented by the ontology 1300. Generally, the better the rules in the data rules store 1307, the better the results from the inferencing engines 1321 and 1306.

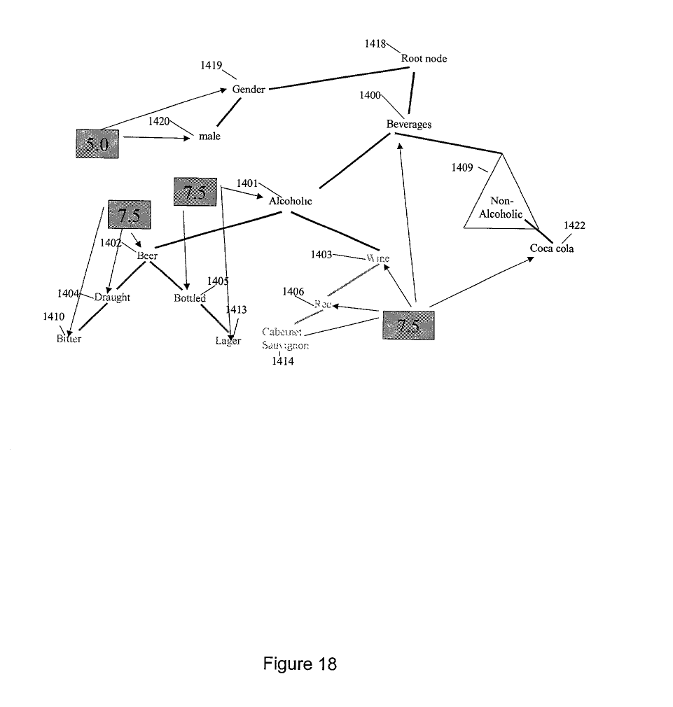

A personalization interest graph (PIG) is shown for example in FIG. 18. The PIG shows the result of inferences made about a user. The user's PIG may be computed based on various triggers. For example, a user's PIG may be computed, either in batch mode prior to the user entering information about himself (for example, through user feed back 1308) or in real-time. The PIG may be computed in real-time when the user arrives at the site or when the user completes login. If the PIG is to be computed in real-time, when the user completes login for example, then the following steps are carried-out. First, the user's characteristic data is retrieved from the knowledge warehouse and submitted to the inferencing engine 1306. The inferencing engine 1306 references the data rules store 1307 to compute the PIG and provide it in a result set. The PIG is combined with the characteristic data to provide the user's profile, which may be stored back in the knowledge warehouse associated with the user.

Next, the profile information is mapped to content in the content store using the search engine/indices mapper 1316 to obtain references to the actual content records that correspond to the personalized information contained in the user's profile. At this time, the content graph may be optionally navigated to find “neighboring” relevant content that may be of value to the user. The content provided back by the search engine/indices mapper component would be ordered based on priority. The set of content references may now be provided to the rendering engine, which may use its inferencing engine 1301, and presentation rules store 1302 and control logic and user interface component 1317 to control the look and feel of the presentation to a user or third party 1320, as well as apply any business logic to the user's personalized view.

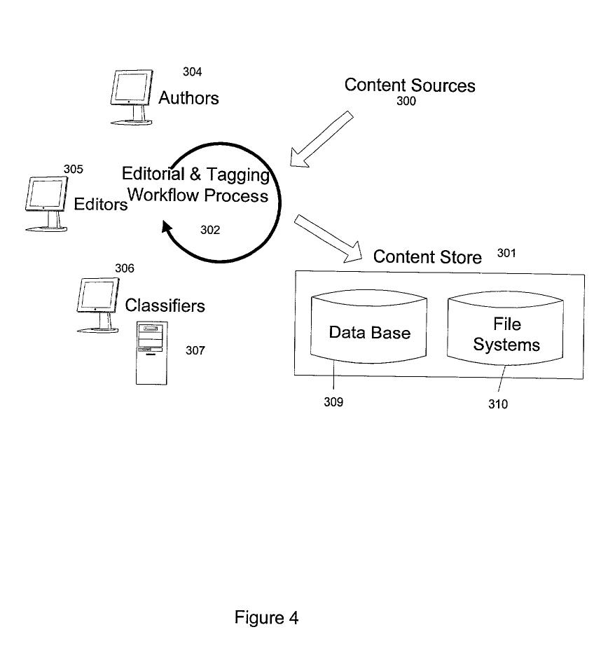

One aspect of the invention is the content management system, an example of which is shown in FIG. 4. A content management system may consist of an editorial and tagging workflow process 302, a content store 301 (with database 309 and file system 310), various roles of users or computers such as content authors 304, content editors 305, content classifiers or taggers 306, 307. The authoring, editorial, tagging as well as other processes may be sub-workflow processes within the overall content management system's workflow process. Additional examples of roles that are not illustrated in the figure, but yet are possible include business people to review the content, graphic designers that are concerned with the look and feel of the content presentation, lawyers to assess any legal implications that the content may have on the business concern, and technical quality assurance people to access the accuracy of the content. Content flows into the workflow from one or more content sources 300. Content exits the workflow and is stored in content stores 301 that may consist of databases, files systems, or other media storage facilities. From herein, the term content store indicates one or more content stores.

Classifiers associate content or information with one or more corresponding tags (also called labels). Tags (labels) are associated with one or more ontology nodes (concepts), thus providing a succinct mapping of the content to the concepts represented by the content. Classifiers may be human 306 or machine based 307. Some classifiers process the content against a domain represented by the ontology and produce a set of tags that the classifier program determines represent the concepts contained in the content. The set of tags may be further reviewed by a human classifier to overcome any limitations of the machine based classification algorithm. Likewise, the human classifier may use the machine based classifier algorithm to provide alternative, or additional tagging suggestions. External content sources may enter into the workflow process of the content management system. The content cycles through the workflow system, at some stage being tagged by the various participants in the content management system. Thus, each content item gets at least one but possibly more than one ontology nodes associated with it such that the node label corresponds to the concepts contained in the content item.

Content may be originated from within the content management system. Editors 305 and authors 304 typically originate content. For example, a news story may be written by an author and then enter into the workflow process. Editors 305 typically edit content provided by authors or external content sources that have entered into the workflow process. The content may be tracked in the workflow process and may cycle amongst various users and machines until it has been formatted, tagged and obtained approval for placement into the content store for publication.

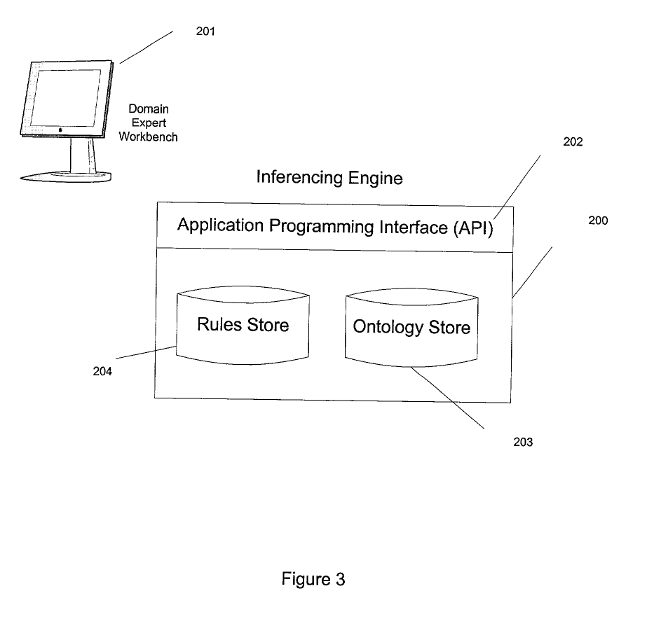

Inferencing systems typically are used to deduce new information from a set of facts or assertions by the execution of rules. FIG. 3 shows a typical inferencing engine 200 including a set of rules stored in a rules store 204 and a graph over which the rules operate, in this case, an ontology stored in an ontology store 203. To utilized inferencing systems, a rules base (set of rules) is created or provided or derived. Typically, rules are provided by experts that have deep domain space knowledge so that the tacit or explicit knowledge of the experts can be captured in the rules. Rules are made up of one or more antecedents which when processed, results in a consequent or inferred result. For example, a rule could be as imply as:

If (A AND B) OR C, then D is implied

In this case, A, B and C are antecedents, and D is the consequent. There are Boolean conditions that are used in the processing of the rule to generate the inferred result. The inferred results of subsequent rules execution should ideally mimic the results that would be deduced by the human expert. Note that the rules base and/or ontology store may be contained within the inferencing engine, or be referenced from outside the inferencing engine. In either case, the inferencing engine applies the rules base to the ontology store to deduce new information.

From herein, the ontology may be referred to as the graph over which the rules may operate. Note that the inferencing engine may reference the ontology from an external source, e.g. database, but typically does include the ontology within the inferencing engine in an internally represented format that provides more efficient inference computation.

Inferencing engines also require an application programming interface 202 so that external users or other computer programs may interface with the inferencing engine. Using the application programming interface (API), questions may be asked of the inferencing engine and inferenced result sets retrieved. Inferencing engines often require support such as the ability to also add, remove, modify rules, or add, change the graph (ontology in this case). The domain expert workbench 201 is illustrated to show that this operational console may itself be an application program that simplifies the way humans interface with the inferencing engine. While it is not part of the inferencing engine itself, the domain expert workbench may be helpful in acting as the human interface to the inferencing engine. The inferencing engine allows the rules to execute over the set of assertions, thus creating conclusions which can thus be used as input over which the rules can again execute to produce transitive conclusions. Such systems have been experimented with and used for various applications and expert systems including, for example, medical diagnostic supports systems and theorem proving systems.

The domain expert workbench 201 typically supports ontology management, rules management, the ability to test various personalization scenarios based on rules or ontology temporary changes, as well as other functions. The present system requires the management of the ontology for capabilities such as loading of the ontology into the central logical store, editing the ontology, and deleting or deprecating parts of the ontology.

The domain expert workbench can also support rule managements so that rules may be added, deleted, evaluated for “what if” scenario testing purposes. When testing various “what if” scenarios, the domain expert workbench may be used to view the inferencing engine results for personalizing one or more users, prior to permanently applying the new rules or changes to the present enabled system.

It may necessary for the ontology to be extended to capture new concepts that may not be already represented by the ontology. This is particularly useful to represent the concept of communities within an ontology. For example, a group of people may be interested in very similar concepts, A, B, and C. It is found that people interested in those same three concepts are very likely to be interested in D also. The data rules base may contain a rule that states users in a community that are interested in A, B and C should be provided content related to concept D. At the discretion of the persons responsible for the ontology and rules management, a new ontology node may be introduced that represents the concept D. From then on content may be tagged using the concept D, instead of using a rule, such as A,B, and C implies D, which may be complex. The concept is now captured as a node in the ontology. This off-loads the inferencing engine from having to always execute the specific rule, and can save inferencing engine computational cycles. Furthermore, introducing new nodes into an ontology provides flexibility for the ontology management team to introduce new concepts that may be related to an ontology, but are not explicitly captured, or easily described by the ontology representation. For example, a community of people may be represented in the ontology as a new node. More specifically, first time pregnant mothers that are unemployed can be represented in the ontology as a new node, and represent the community. It may be more efficient or conceptually convenient to represent this community as a new node, rather than always requiring a rule to execute if a person is a first time pregnant mother and unemployed.

Another important component of the personalization system is a knowledge warehouse where minimally, user “characteristics” are stored. Characteristic data is information about a user that is obtained from external (not-the present system) sources or is information or preferences provided by the user or an agent acting on behalf of the user. Data that is imported into the knowledge warehouse from external sources is termed source data. Any data that is captured by the system without the user's explicit knowledge or that does not require the user to take direct action, is considered implicit characteristic data. data that is obtained as a result of the user making explicit choices or decisions is considered explicit characteristic data.

For example, medical claims data that is brought into the knowledge warehouse is considered characteristic data. Also, if the user specifies that their favorite color is blue, for example, and this preference is determined by the present system designers to be relevant enough to be stored with the user's information in the knowledge warehouse, then this information is also considered characteristic data of the explicit type. Finally, click stream data that indicates the users actions with respect to their usage of one or more web sites is also considered to be characteristics data of the implicit type.

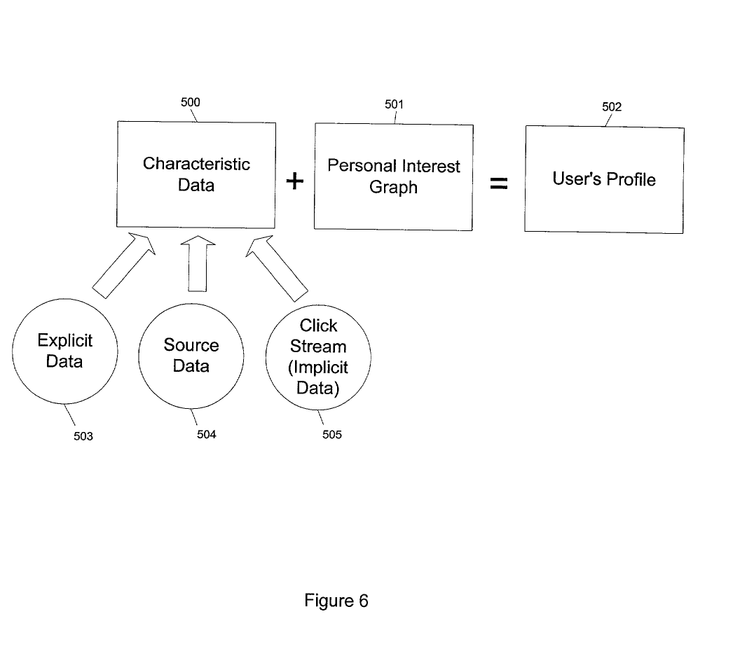

The knowledge warehouse is a repository for all types of information about users, including but not limited to explicit personal preferences, click stream data providing a historical trail of the users activities at a web site, personal information about a user that is obtained from external data sources (e.g. medical records, financial information). In this invention the knowledge warehouse may also contain information about users that is inferred via the inferencing engine. This information that is inferred about a user and that was obtained as a result of running the characteristic data through the inferencing engine is termed a personalization interest graph (PIG). FIG. 6 illustrates the user's characteristics data 500 combined with the user's associated PIG results 501 in a user's profile 502. In an alternative explanation, the characteristic data may consist of user source data 504, implicitly captured data 505, such as click stream, and explicit user data 503. The PIG is inferred data.

The PIG itself may be in the form of a tree, simple list of corresponding ontology nodes or DAG representing the user's inferred and non-inferred interests. If the PIG is in the form of a tree, or DAG, then the structure of the PIG may potentially be exploited by the other present system components, as will be illustrated in the preferred embodiment. The PIG is computed by inputting the characteristic data into the inferencing engine. The inferencing engine utilizes its rules base to apply the rules to the characteristic data applied against the ontology. The inferencing engine may repetitively fire rules that result in deductions or inferred data, until some predefined stopping point or until no further rules can possibly be fired. When no further rules fire given a specific user's input data, then the computation is considered to have reached a fixed point. The set of nodes that accumulated in a tree, list or DAG make up the PIG. The PIG can be considered as a subset of the ontology, but different in that nodes also have associated weights indicating their importance to the user (user's interest).

Each node in the PIG contains a weighting indicating the degree to which the user is interested in the concept. Nodes in the computed PIG that have a larger weighting may be considered to be of greater interest to the user. The nodes in the ontology do not have weights associated with them. Nodes in the profile, however, are weighted. Characteristic data may be initially be weighted by explicit user choice, or via algorithms. For example, node weights may range from 1-10 points, where 1 indicates weak interest and 10 indicates strong interest. For the purposes of illustration, the weight range of 1-10 will be used and referenced throughout this invention. Characteristic data that is imported into the knowledge warehouse may be initialized with a medium interest level, for example. A domain expert may choose to weight different user data with various weights. Also, users may explicitly make choices as to their interests and thus affect how the weights are changed in the characteristic data. Once the characteristic data is weighted, it may be used as input to the inferencing engine to compute the PIG.

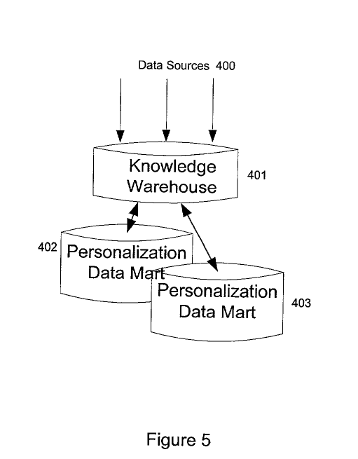

FIG. 5 shows an example of a knowledge warehouse 401 with Personalization data Marts 402,403. The data marts are typically copies of the knowledge warehouse, acting as front ends for other components to get access to cached content of the knowledge warehouse. The knowledge warehouse is often a large repository of massive user information. As such, it can become overly burden if there is too much interaction with other components that need to interact with the knowledge warehouse. Data from external sources 400 may be loaded into the knowledge warehouse for use in providing deep (richer and more precise) personalization. As such, data marts are often introduced to off-load the knowledge warehouse and support access to the data from other components. For example, in web services the application servers very frequently need to access the user information stored in the knowledge warehouse. Instead of making requests directly to the knowledge warehouse, the application servers may make requests of the data marts to access such information. Given this architecture, the data marts should be kept in synchronization with the information contained in the knowledge warehouse. However, the frequency with which the information is resynchronized becomes a parameter that can be tuned to achieve optimal or better overall performance. In FIG. 5, the data marts are used to store cached personalization information that is retrieved by the inferencing engine, for example, to compute inferenced personalized results for individual or groups of users.

Personalization data marts can also be used for analytical study of a population of users. For example, one may create analytical studies using the data in a personalization data mart (obtained from the knowledge warehouse) for better understanding the purchasing behaviors of a class of users. This may in turn, produce insight as to specific trends of a user population that in itself, may provide important strategic business decision support for other companies. Thus, the analytical information that is extracted from the knowledge warehouse is considered “data exhaust” as it can provide important information of high value and of strategic importance that can be sold to other companies or entities.

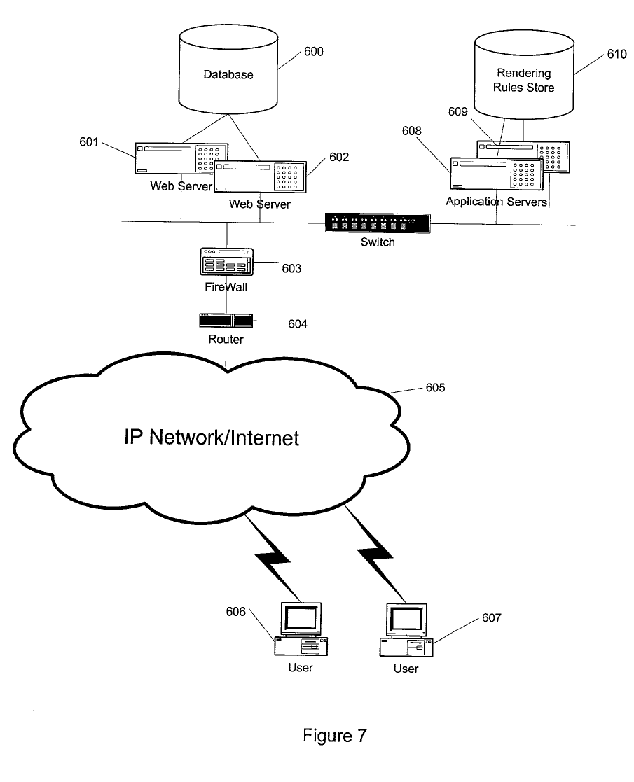

The rendering engine is an optional component of the present system. An example of a typical web based rendering engine is shown in FIG. 7. In particular, the rendering logic may be contained in the web servers 601,602 and/or application servers 608, 609 and utilize the display rules stored in the rendering rules store 610. The display rules may control how the personalized information is presented to the user on the screen, or which parts of the profile are displayed to the user for how long and how often.

Overall in the present system, there are several different categories of rules applications. Namely, data rules, and display rules. The data rules are rules that are relevant for user supplied data or information and are applied against user characteristics or profile information for use in deducing new or more precise personalized information about a user. The rules themselves, may specify the relationship of concepts in the ontology, independent of a specific user characteristic data. The rules may be written by a domain expert so that the knowledge held by the domain expert is codified as rules in the system.

Display rules control what information contained in the user's profile is actually rendered to the user, and in what format the information may be represented. Display rules may prioritize the information contained in the PIG that is to be displayed to the user based on short-term business needs, for example. Rendering engines can typically be obtained off-the-shelf. Examples of companies that provide such rendering engines are Broadvision, ATG and OpenMarket.

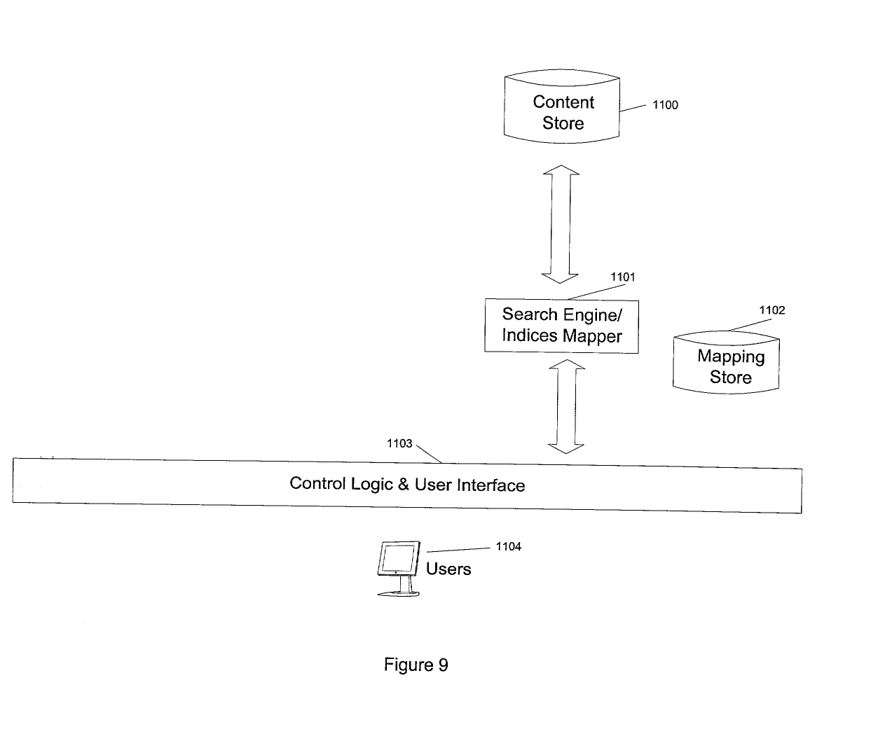

The Search Engine and Indices components 1101, 1102 illustrated as part of FIG. 9 is used to provide a mapping from the computed PIG or user's profile to the content contained in the content store 1100. The resulting content may then be rendered by the control logic and user interface 1103 to the user 1104. The Search Engine may accept requests from other components, given a set of interest nodes, and/or labels, and execute search algorithms to obtain a set of content that maps to the input set of interest nodes or labels. The search algorithms may operate directly on the content store, or may operate over one or more indices to speed-up the time required to locate the corresponding content. Indices are precomputed mappings from ontology nodes and/or labels to actual locations of the corresponding content. The Search Engine may operate its algorithms over the Indices to more rapidly retrieve the relevant content. Incorporated herein are two techniques for producing link-based rankings of content, resulting in the creation of indices for quickly looking up relevant content. The first reference included herein is by Page and Brin titled “The PageRank Citation Ranking: Bringing Order to the Web, Jan. 29, 1998. The second paper is included by reference by Jon M. Kleinberg titled “Authoritative Sources in a Hyperlinked Environment”, published in the Journal of the ACM, 2000.

The present system may operate using de-identified users in a system that provides de-identified authentication for users. This system may be represented as a data source with names and personally identifying information eliminated. A third party may provide the information about the de-identified user data to a data warehouse. When needing to provide personalized information, the present system may contact the third party and receive verification that the user is to be authorized for access to the system and associated with specific user information. In this regard, the identity of the user remains confidential. However, the present system may use the user's information to provide a personalized site or content once verified.

The present system operates the same regardless of whether the user is identified or de-identified. That is, a user's identity is transparent to the present system. However, all users should be uniquely and consistently identified throughout the present system. For example, if a de-identified user's click stream data is collected and used for future PIG computations, it should be collected with respect to a unique user identifier (e.g., number). Thus, the present system may provide a de-identified AND personalized user experience to the users of the system.

As stated earlier, the present system provides the capability to inference over an ontology to provide deep personalization to system users. A typical performance trade-off in inferencing systems is the trade-off of space (memory) versus time (CPU computation). That is, the data rules base may be executed over the ontology to create a larger graph representing the entire state space that is possible to explore. For example, when a new consequent is computed, a new node may be added to the ontology that represents the consequent. Furthermore, one or more links may be introduced between the antecedents and the consequent nodes, to represent the Boolean conditions contained in the rule that correspond to the new consequent node. The consequent node may be used again as an antecedent in one or more rules from the rules base to create new consequent nodes and links between antecedents and new consequents. All rules in the rule base may be executed until no condition for which any rule fires is present, resulting in a fixed point condition and a maximal ontology graph. The resulting graph would represent the maximal state space. Note that the order with which rules fire is important and can result in different resulting maximal ontology graphs. Furthermore, as new rules are introduced into the rules base, the maximal ontology graph may be required to be recomputed.

The PIG may be computed using a maximal ontology graph by starting with a user's initial set of interest nodes representing the user's characteristic data. Each node in the characteristic data may be followed in the maximal ontology graph to new nodes. The new nodes are added to the set of interest nodes. The maximal ontology graph traversal continues until no more new nodes can be added to the set. The final set is considered to be the user's PIG.

For a non-trivial ontology, storing the maximal graph may be inefficient due to the large number of nodes in the maximal set. Thus, a purely space based approach to inferencing based personalization may be inefficient. However, for small ontologies, utilizing the maximal graph may be efficient. The present system may provide personalization by exploiting space, time or combinations of both to provide inferenced based personalization. It is recommended but not required that the PIG be computed for each user, by executing the rules in the rules base, because the time-based inferencing approach can result in a more scalable system for large ontologies.

The computation of the PIG may be carried-out on demand or in real-time or in batch mode. The real-time PIG computation may be useful for scenarios when the user is interacting with the system, providing important click stream data or making explicit personalization oriented selections that are likely to cause a significant change to the current PIG. In this case, the PIG may be recomputed in real-time. Also, the PIG may be computed immediately after a user logs into the system, or when the user first arrives at the system, so as to provide the most time relevant PIG.

While real-time personalization can provide rapid PIG re-computations, it may not always be scalable when providing large-scale personalization services for web sites that service hundreds of thousands, millions, or more users. In this case, it may be beneficial from a performance perspective to carry-out batch PIG computations for a set of users. The output from the batch personalization computation (PIGs) may be useful in improving the performance of the personalization system, from the user's perspective. For example, if the user characteristic data has not changed since the last batch personalization computation was carried-out, then there would be no need to recompute the PIG since the PIG output would be the same. This can result in significant savings in computation, and the end users perception of the responsiveness of the system. Thus, the invention contained herein includes real-time as well as batch PIG computation for providing deep personalization.

The same inferencing techniques that are applied to the user characteristic data may also be applied independently to the content in the content store, to enrich the set of tags associated with each content item. Each content item is typically tagged against the ontology during the content management workflow process. Also unique to this invention is the idea that the inferencing engine and rules store can be applied to each item in the content store to enrich the tags (attributes) that describe the data. This technique thus causes the expert's domain knowledge, by way of the rules execution, to be applied to each content item, thus enriching each content item. The resulting enriched content may be stored in the form of a set of graphs, one for each content item, where each graph is called a content information graph (CIG).

The CIG information can be used in several ways to provide more precise personalization. For example, when a PIG is computed for a user and provided to the Search Engine and Indices component so that the corresponding content may be obtained, the PIG could be compared against the CIG to compute a nearest match. Those graphs that are nearest would potentially represent the best matches from PIG to content items and thus be used for presentation to the user. It is possible that the PIG and/or CIG may be represented as lists, in which case they are not graphs. There are known technique in the prior art for computing the distance between PIG and CIGs, when represented as a list, or a graph.

It was highlighted above how the inferencing system may trade-off time and space to obtain a user's PIG. The method described illustrates how the data rules in the data rules store may be executed against the ontology to compute a maximal ontology graph. Likewise, a graph using the content store may be constructed amongst the content items showing their relationship with each other. Such a graph can be constructed using known techniques derived from contemporary search engine technology, but with some algorithmic modifications. The algorithms already referenced herein [Page and Brin, Jon M. Kleinberg] describe how to construct content graphs that rank the relationship of content to other content for the purposes of providing search engine results. This technology can be applied to tagged content in the content store, to construct a graph where each link in the graph shows the rank or weight of a content item with respect to all other relevant content items or nearest neighbor content items.

The resulting graph is referred to as the content graph. The content graph acts to enrich the content store, and is another technique used for providing precise personalization to users in the system. That is, if a user is directed to a particular content item, the content graph may be followed starting at the node corresponding to the particular content item, to locate other highly relevant content items that may be of interest to the user. The link ranks or weights provide an indication of how important a neighboring content item is to the initially referenced content item. Content that is considered of a specific weight or higher importance, may be obtained from the content graph, starting at an initial content item's node in the graph and navigating in n-dimensional space outward to neighboring nodes, following the weighted edges to other content nodes. Various algorithms exist in the prior art to compute the content graph and to navigate the graph. The result is a broader set of content that may be rendered to the end user as part of the personalization system. Those neighboring items of the highest weight and thus the strongest relevance to the initial content item's node may be returned as a result of navigating the graph.

The ontology that is used by a particular system implementation may be referenced as part of a workflow system that maps to specific processes that businesses may use to engage their customers in the offline world. One use of such an ontology-guided workflow may be to help users determine their interests or what information or services they would like to obtain. The ontology represents the steps that businesses may follow to identify and meet the need and interests of their customers. Walking users through workflow processes is not a new concept. However, by mapping the workflow process to major concepts and business processes represented by the ontology, or more than one ontology, the user may more quickly find information and services with which they are most interested, and the present system provider may more easily and efficiently help the user personalize themselves with respect to the present system. It helps place the user in personalized categories that are highly specific, useful and situational. These personalized categories can help the user more deeply personalize over time as more click stream activity is captured and processed, as additional user data is provided to the knowledge warehouse, and as the user makes additional explicit personalization choices. These personalized categories also represent captured expert knowledge within a business. They help businesses to augment or even replace people in their business that are experts in engaging and meeting the needs of their customers, for example, customer service representatives, sales staff, or case workers. One can use the coupling of a process workflow guided by the ontology as a core business workflow capability provided by the system provider.

Several applications of the system are possible including uses for deeply personalized user experiences, including but not limited to the suggestion of products, services and information to users based on a priori user information, explicit user provided characteristics, click stream user activities, and inferred information. The users may be Internet users or other types of users. The present system may be used to act as a trusted advisor.

For example, the present system may be used in a personal health management system to enable users to be provided with specific and relevant medial information related to their medical conditions and medial interests. Some ontologies that may make up the ontology in such a system can include the READ (http://www.visualread.org), SNOWMED (http://www.snomed.org), or ICD9 encoding schemes. User's characteristic data may include pharmaceutical data, medical claims records, explicit interest choices provided by the user's themselves. The application may be implemented using de-identified user authentication such that the present system operating organization would not know the true personal identify of the end user. Thus, one example application is the personalized AND de-identified medical advisory or wellness service, and example of which can be found a, Personal Path Systems, Incorporated.

Another application of the present system includes the precise personalization of users of financial portals that may provide management services of user's finances, included but not limited to 401K, stock portfolio management, overall personal or business finance management, tax services. In such applications, the user's characteristic data may include current financial holdings, financial transactional behaviors, click stream or navigational history at financial oriented web sites, to name a few possibilities. The present system could provide such users with more relevant information and services to better help them manage their assets. Again, such a service may operate using the de-identified user system referred to above.

The present system enhanced web service may be utilized to recommend products, services and information to users in a identified or de-identified way. For example, the present system enhanced financial web service referred to above may recommend that the user purchase specific financial instruments and services, based on the inferenced results.

In another application of the system, users may be provided with customized navigational experiences depending on their personalization profiles. For example, as users navigate a present system capable web site that also includes the Business Process Workflow module, the user may be navigated to different pages of the web site based on the users profile and navigational behavior.

In another application of the system, the present system may provide users with deeply personalized search engine results. In a typical search engine application, users typically type a keyword or phrase to find relevant information. The search engine often uses the provided explicit keywords to search for relevant content. In the present system enhanced search engine application, the keywords provided by the user may be assumed to be characteristic data, and the rules engine may be run against the keyword input to compute a PIG. The inferencing engine may execute the rules in the rules store to compute the PIG. The PIG may then be used to locate relevant content in a search engine to be offered as search results to the user. If the search engine application allows for the user to be identified to the application, then the user's personal information or characteristic data may be integrated with the search keywords explicit characteristic data to compute the PIG. Again, the PIG may be used to locate the relevant content. In this application of the invention, the keyword explicit characteristic data provided by the user may be more heavily weighted than the other characteristic data known about the user, so that the search engine results are skewed more towards the provided search keywords.

Another application of the invention is Customer Resource Management (CRM). Assume that a business has the present system and provides a call center where customers may call to ask questions, get service of any kind, or purchase items. The customer care representative receives a call (over the public telephone network or Internet) to provide customer service to a customer of the business. Once the customer care representative receives the call and identifies the user, the customer care representative may enter the userid of the caller into the present system and lookup the user's interests. The present system may provide the customer care representative with detailed procedures, preferences, corresponding to the customer, that may aid the customer care representative in providing customized or precise personalized service to the particular user. Thus, in this application of the invention, the customer care representative is receiving the personalization on behalf of the customer, and acting on the information to provide more precise personalized attention to the customer.

In another application of the invention, the system may provide expert guidance to users, guiding them through a workflow or decision making process, while simultaneously utilizing the rule store and Inferencing Engine expertise to guide a user. As user's interact with the system, making choices and decisions, such interactions may cause rules to execute, thus providing the user with new information, options, or choices upon which to act. Furthermore, the present system can use the characteristic data to aid in providing expert guidance through a decision-making process or workflow.

The present system may be used in any web site or service where extensive prior knowledge of users can be gathered and where an ontology can be described or otherwise obtained which describes meaning in a business context for the attributes of the user data, and where it is possible to use an inferencing system with domain expert provided rules. The field of use is broadly based since the present system allows the enterprise to present information, advice, or commerce (offerings) with keen insights into the interest areas of its users.

The detailed description of the preferred embodiments will be provided by way of illustrated examples of the present system including an Internet web service that provides the sales of beverages to Internet users, including beer, wine, mixed drinks, soda, etc. The web site also provides community to its beverages user base. First, the examples illustrate the minimal The present system and the steps involved in providing precise personalization for several users. Then, the personalization is enhanced with explicit and implicit characteristic data to show how the resulting PIG is changed. Next, a process by which the PIG output is mapped to content and displayed is shown. Finally, the content graph component and its interactions in the system is shown. In the present system, several components should be initialized with example data, as is done below.

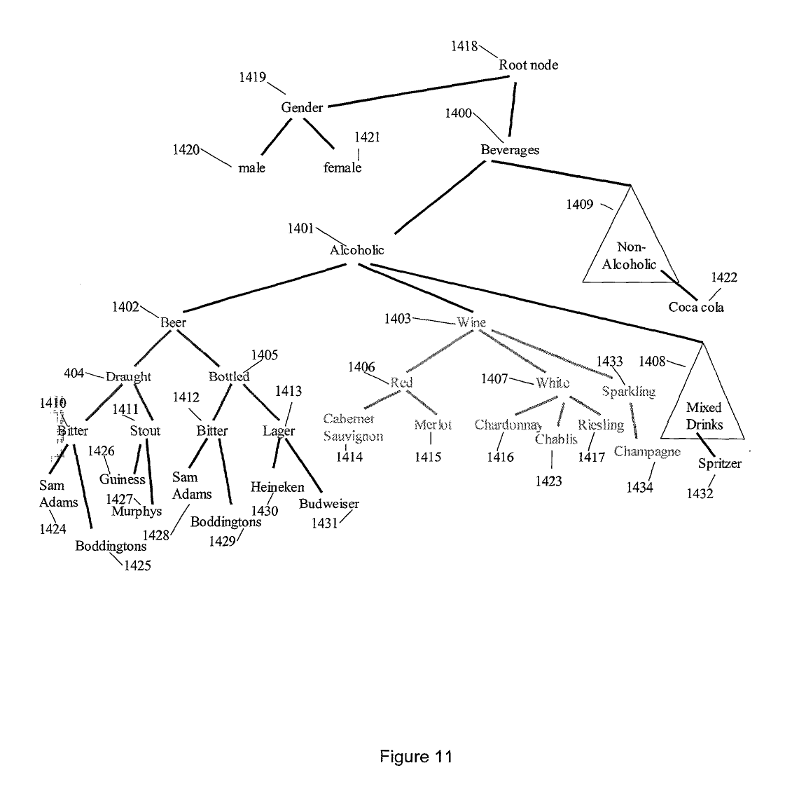

FIG. 11 shows the reference ontology that will be used in the description of the preferred embodiment. The ontology includes two sub-ontologies, mainly, the domain of beverages and gender. Only a portion of the ontology describing alcoholic beverages is illustrated in the figure. Mainly, all beverages under the Alcoholic node 1401 show different types of alcoholic beverages, including beer 1401, wine 1403 and mixed drinks 1408. The gender 1419 sub-ontology is very simple and used to distinguish the concepts of males 1420 and females 1421. The gender and beverages sub-ontologies are tied together by a parent root node 1418 to create the ontology of reference. Ontologies and sub-ontologies may have different implied link semantics and the rules captured in the system should be written to correspond to those semantics. For example, FIG. 11 shows the gender sub-ontology. Node Gender 1419 has a “isa” link semantic to nodes male 1420 and female 1421. Likewise, the link semantics in the beverages sub-ontology is the “isa” semantic. For other sub-ontologies, such as for medical disease classification, the link semantic may be “has”. For example, a parent node representing the concept of “disease” point to a successor node “heart disease” implying a link semantic of “has”. That is, a person with disease may have heart disease. In this case, the rules store would be written using the “has” link semantic for the sub-ontology.

For the purposes of describing the present system, assume that the number label assigned to each node in FIG. 11 is actually the node identifier of the node in the ontology. It is also assumed that the text label describing the concept that the node represents, is actually the label of the node. For example, an ontology node may contain the following fields:

Node label (short name that captures the concept the node represents)

Node Identifier (unique over the entire ontology)

List of nodes that point to this node

List of nodes pointed to by this node

State (active, deprecated)

Timestamp (time of last change of node)

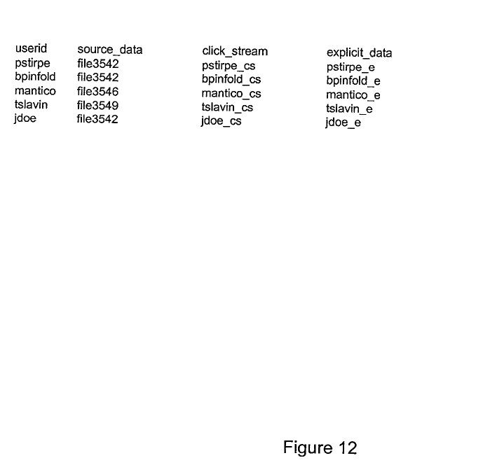

FIG. 11 explicitly illustrates the node identifier and node label fields. FIG. 12 illustrates a possible example table in the knowledge warehouse showing the user identifiers (userid), and references to their input source data, click stream history, and explicit user choices that may be available. To simplify the example, it is assumed that each entry in the table references an actual file name whose file contains the respective data in XML format, for example. This example is contrived only to illustrated the present system concepts, and is not necessarily how one may actually implement the present system. Note that the userid's in this case may be derived from the actual names of the users. In a de-identified present system, the user's may be represented by non-identifiable numbers.

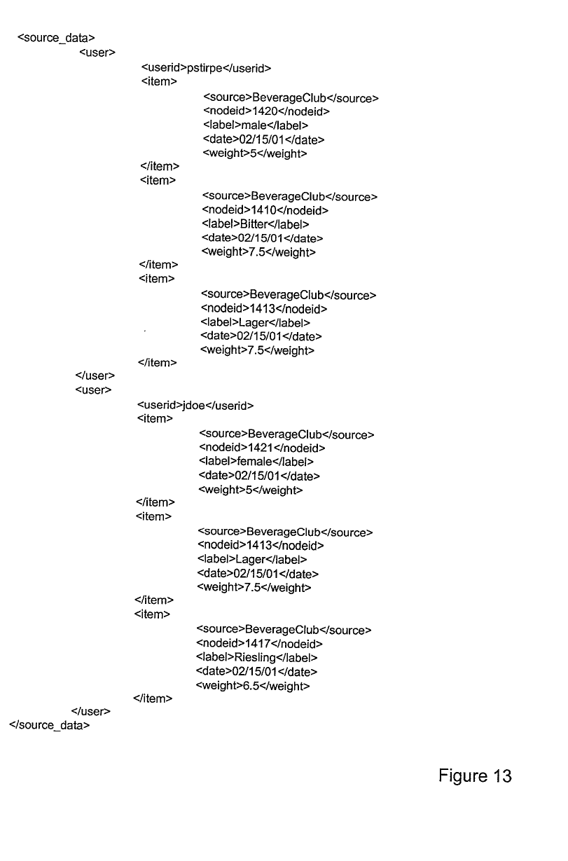

Let us assume that the data file named file3542 initially contains the source data that describes the source data for users pstirpe(Paul Stirpe) and jdoe (Jane Doe) as shown in FIG. 13. The weights assigned to the items in the knowledge warehouse may be assigned to nodes based on the importance of the sub-ontology to which the node belongs. For example, it may be considered more important that user pstirpe likes Bitter draft beer (node 1410 compared to that fact that pstirpe is a male (node 1420. Since the beverages sub-ontology is larger, more detailed and captures the central concepts of the beverages web site, the present system may initially weight the nodes in the users data record that specifies beverages, higher than nodes that are part of other sub-ontologies, such as the gender sub-ontology. Also, if a user has more interest in a particular concept because the source data specifies repeated use of a particular concept, then one could assign a higher weight the concept in the knowledge warehouse data associated with the user. For example, if it is known by the local wine club that a the user only purchases 5 cases of Red Merlot wine ever year, this information when input into the knowledge warehouse may be weighted with a high weight, indicating the strong preference of the user for Merlot.

Next, let us assume that the data rules store is initialized to contain the rules, input by a beverages domain expert. The knowledge captured in the rules may be the result of years of study and experience obtained by the beverage knowledge expert. The domain expert workbench interface component may be used to interact with the system to input, edit the rule store. The example rules are as follows:

If (likes1410 AND isa1420 then likes1414 (rule 1)

which means if the user likes bitter draft and is a male, then they will also like Cabernet Sauvignon.

If likes1414 AND likes1413 AND isa1420 then likes1422 (rule 2)

Which means if the user likes Cabernet Sauvignon and likes Lager and they are male, then they will also like Coca Cola.

If likes1413 AND likes1417 then likes1422 (rule 3)

Which means if the user likes Lager and Riesling white wine, then the user will also like Coca Cola.

Isa1421 AND likes1422 AND likes1403 then likes1434 (rule 4)

Which means that if the user is a female, likes Coca Cola and likes wine, then they will also like Champagne.

Furthermore, the data rules stores may contain some general constraint rules that make broad implications over the ontology, such as:

Weight(node) Max[Weight(each successor nodes)] (rule 5)

Which indicates that the weight of a given node is equal to the maximum weight of all of its successor nodes. This rule may be applied after each application of the specific rules, to propagate the interest throughout the PIG computation. The intuition captured by the rule is that a predecessor node is of interest to the extent that its successor nodes are of interest. This is an example of a general constraint rule. Other constraint rules may be used by the system.

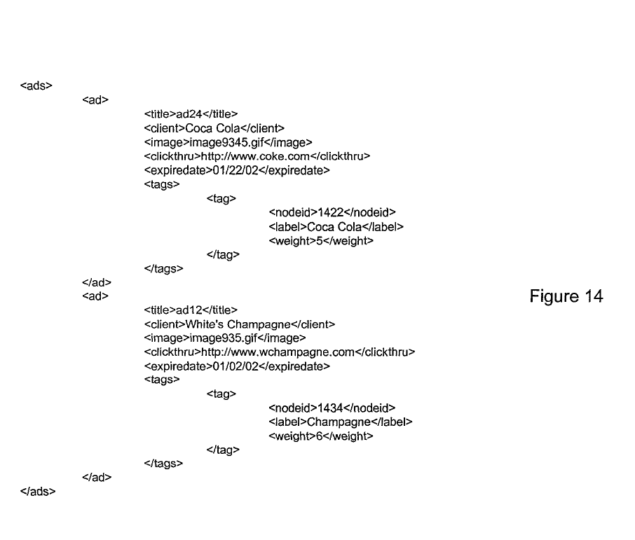

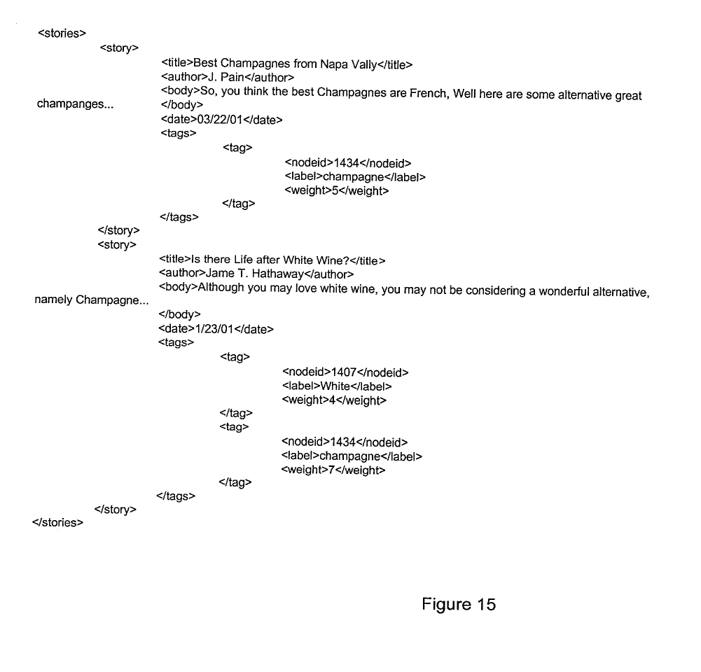

Finally, before one can illustrate the system, the content store should be initialized with content that has been tagged with respect to the beverages ontology. Assume the following content shown in FIGS. 14 and 15 is a sub set of the content contained in a file system-based content store. In this example, only advertisement content and news/information stories are used to illustrate the present system. The content types used by a general system enabled system, however, are unrestricted, including multimedia content or other types.

Associated with each content item, are a set of tags that represent labels or node ids of ontology nodes. The content items have been tagged with one or more corresponding concepts in the ontology via the content management workflow system or some other such means. For simplicity, several types of content are illustrated, including advertisements and news/information stories. Again, the content is assumed to be in XML format, as shown below: The ad content is shown in FIG. 14. The ad content shows various advertisements, their respective titles, the client or sponsor of the ad, the image used to render the ad, the url that the end user is brought to once they click on the ad's image, and the expiration date of the ad. Furthermore, each ad has associated with it one or more tags corresponding to the reference ontology. Each corresponding tag is weighted to indicate how much the ad is about the concept represented by the tag.

The example subset of news/information stories content is illustrated in FIG. 15 The news and information content describes the stories title, author, the body of the story, the date the story was written. Associated with each story are a set of tags that correspond to the concepts captured by the story, and their corresponding weight. For example, the first story “Best Champagnes from Napa Valley” has been tagged with node 1434 (Champagne) with a weight of 5. Thus, the story was considered to be mainly about Champagne and no other concepts. However, the second story is tagged with the node 1407 (white) with weight 4 because the story mentions the origins of the Champagne from white wine. However, the second story is tagged with node 1434 (Champagne), with a weight of 7 because the story is mainly about Champagne.

At this point, the system is initialized with the knowledge warehouse data store, data rules base, content store such that the PIG may be computed. Next, the interaction that leads to the real-time computation of the PIG is illustrated.

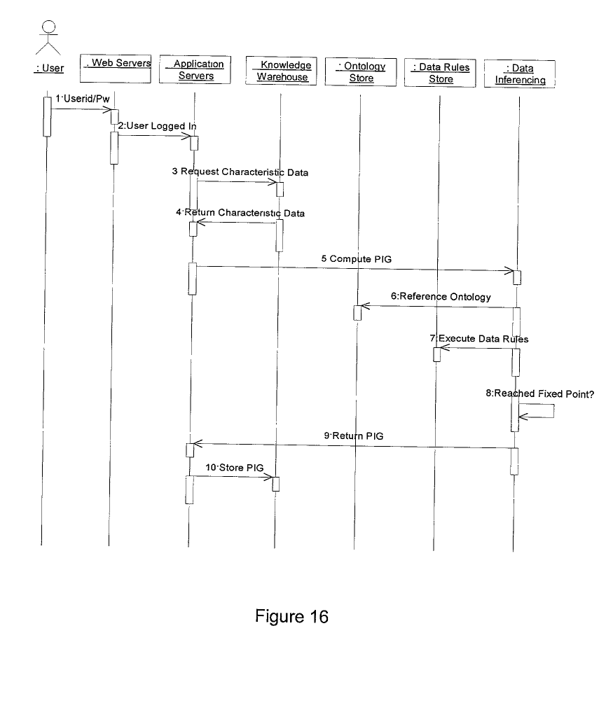

The PIG may be computed as follows, as is illustrated in FIG. 16. Many other interactions are possible that result in the computation of the PIG. FIG. 16 illustrates only one such interaction. First, the user may log into the web site, providing his/her userid and password. The web server passes the user off to the application server to initiate the PIG computation. The application server requests from the knowledge warehouse the specific user's data record including all characteristic data shown in step 3. Let us assume that this is the first time the user has logged into the beverages web site, and thus there is no click stream history nor explicit user choice data type characteristic data. Only the source data obtained from a third party that has been imported into the knowledge warehouse is available for input to the PIG computation process. The knowledge warehouse returns the characteristic data to the application server, shown in step 4. The application server requested that the data Inferencing Engine compute the PIG, shown in step 5. The data Inferencing Engine references the ontology (step 6) to initialize the ontology (working copy) with the weights of those nodes contained in the characteristic user data. In this case, assuming that the user is pstirpe, the characteristic source data (shown in FIG. 13) would cause the node 1420 (male) to be initialized with a weight of 5, node 1410 (Bitter) to be initialized with a weight of 7.5 and node 1413 (Lager) to be initialized with weight 7.5. In step 7, the data rules store is allowed to run the data rules against the working ontology copy, applying the rules until a fixed point is reach in step 8. The processing of the PIG computation may be terminated prior to when the fixed point is reached. This is an implementation decision that trades time and space and the quality of the resulting PIG. For example, it may be adequate to obtain ten nodes of a given sufficient weight, prior to terminating the PIG computation.

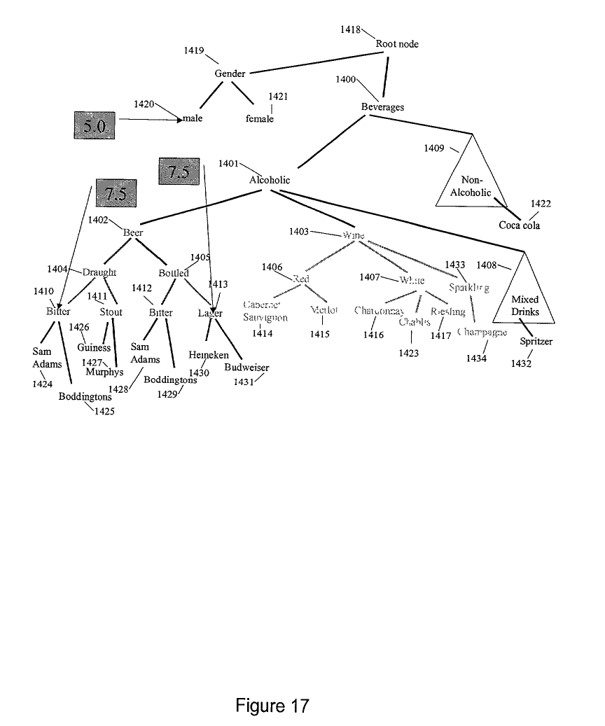

As each rule fires, new nodes are explored in the ontology and their respective weights are calculated and assigned to the nodes in the ontology. For each new node visited, the new node and its corresponding weight is added to the output list or graph of nodes and their corresponding weights. When the fixed point is reached, the output is considered to be the PIG. For example, given the characteristic data of user pstirpe shown in FIG. 13, the working copy of the ontology may be initially marked as shown in FIG. 17, where the Bitter, Lager and Male nodes are marked with the initial weights. The intermediate inferencing states are not illustrated in this example, but the final resulting PIG is shown in FIG. 18 and the intermediate steps outlined. Note that only those nodes that have a weight are part of the PIG. The general rule (rule 5) may be applied to the graph after each application of all other rules in the data rules store. An example inference engine computation may be as follows illustrated in the following steps, starting with the marked ontology copy shown in FIG. 17:

1. Rule 5 repeatedly fires, causing nodes 1404 (Bitter), 1405 (Bottled) 1402 (Beer) 1401 (Alcoholic), 1400 (Beverages) to be assigned node weight 7.5 and node 1419 (Gender) to be assigned weight 5.0.

2. Rule 1 fires, causing node 1414 (Cabernet Sauvignon) to be added to the PIG

3. Rule 5 fires, causing node 1414 to get assigned weight 7.5, as well as nodes 1406 (Red) and 1403 (Wine) and again 1401 (Alcoholic). Since 1401 (Alcoholic) already has been assigned weight 7.5 in step 0, no change is made to its assigned weight.

4. Rule 2 fires, causing node 1422 (Coca Cola) to be added to the PIG

5. Rule 5 fires, causing subsequently node 1422 (Coca Cola) to get assigned weight 7.5 and all predecessor nodes inside the non-alcoholic sub-ontology to get assigned weight 7.5.

6. Computation terminates as no more rules can be applied (fixed point reached).

Once the inferencing engine completes its work, the results are provided back to the application server, as shown in step 9 of FIG. 16, which may subsequently store the PIG results in step 10. The working ontology copy that has been used during the computation and contains weighted nodes, may be discarded or all weights may be cleared in preparation for the next PIG computation. The resulting PIG can be used to provide pstirpe with Coca Cola related information, or information that is not obviously derived from the initial source data, but with inferencing over an expert supplied rules base, provides new personalized information about user pstiipe.

The order in which the rules are applied is pertinent to the final PIG computation. The invention includes all inference engines and their relevant rules ordering algorithms, as a component of the present system. The root node, which is used in this ontology, is introduced to join together two disparate ontologies (beverages and gender), and thus does not represent a concept. Thus, rule 5 is not applied against the root node, and the root node is not included in the PIG result. Again, it does not represent a concept and thus is not part of the PIG result set.

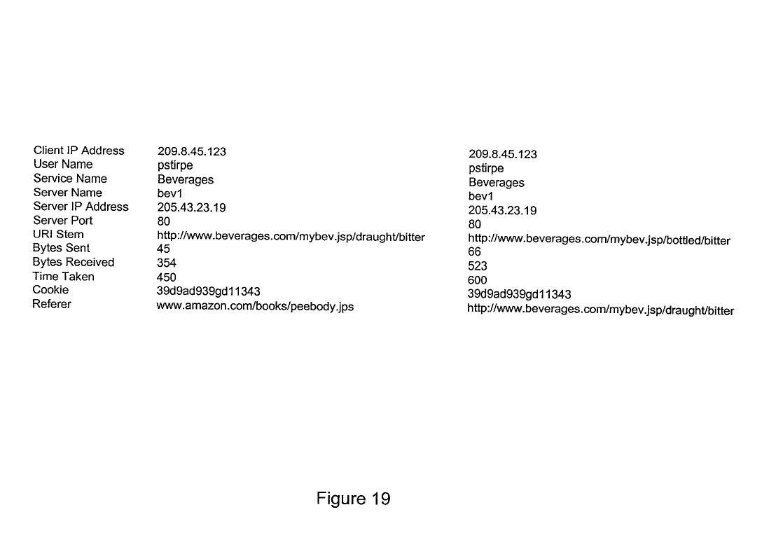

Next the changes in PIG computation and resulting level of personalization based on the user's implicit feedback are illustrated. Assume for this example, that user pstirpe, once logged into the present system enabled beverages web site, accumulates some click stream information indicating that the user is strongly interested in Sam Adams Bitter Draught and Bottled beer shown in FIG. 19. The information accumulated as part of the click stream may be obtained from any standard web server. In this example, the web server used is Microsoft's IIS 5.0. FIG. 19 shows that the user pstirpe navigated from the web page at amazon.com to the page at the beverages web site. Furthermore, the user pstirpe stayed at this page for 450 seconds. The next click stream entry for user pstirpe indicates that the user navigated to the beverages web site page, and stayed at that page for 600 seconds. Assume that these two entries are the only click stream activities made by the user pstirpe. Assume that the pages to which the user has visited have associated with them the corresponding ontology nodes mapped as tags. Furthermore, assume that the click stream behavior is considered very significant given that the user stayed at those pages for the period of time indicated. Given these conditions, the present system may weight the click stream activities with a relatively high weight, such as 8.5 units of weight. Thus, there is a process by which the click stream feedback is mapped against the ontology and assigned weights. There may be various ways of assigning the weights to the click stream history. For simplicity, assume that the weight is based on length of time the user stays at the page. The weighting could also be based on the number of times a user visits one or more pages with similar corresponding ontology tags. That is, if the user navigates the web site hitting different pages that happen to map to the same ontology node or nodes, then the weight of that ontology node(s) in the click stream history can be assigned a higher value. Note that the tags assigned to the click stream activity may be associated with a whole web page, section of the web page, or any element within the web page. When the user hits (click on) or potentially mouse-over a section of the page that has tags associated with it, the tag information can be added to the click stream history for incorporation into the user's characteristic data.

The process of mapping the click stream activities to the ontology and into the characteristic data can follow as such (the example algorithm is based on user pstirpe, but can be applied to any user).

1. The web server click stream logs may be accumulated from the web servers.

2. The logs may be scanned for click stream history of the user pstirpe, in this example.

3. The tags associated web pages or parts of web pages, to which the user has visited, may be accumulated in a list.

4. Count the total number of times the same tag is represented in the list, for each tag.

5. Normalize the total number of times each tag is represented in a scale from 1-10.

6. This number is the weight that can be assigned to the click stream record contained in the knowledge warehouse for user pstirpe.

7. End.

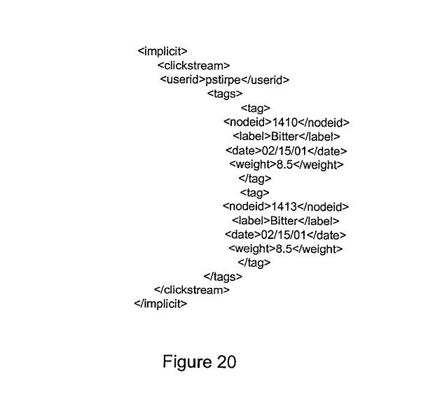

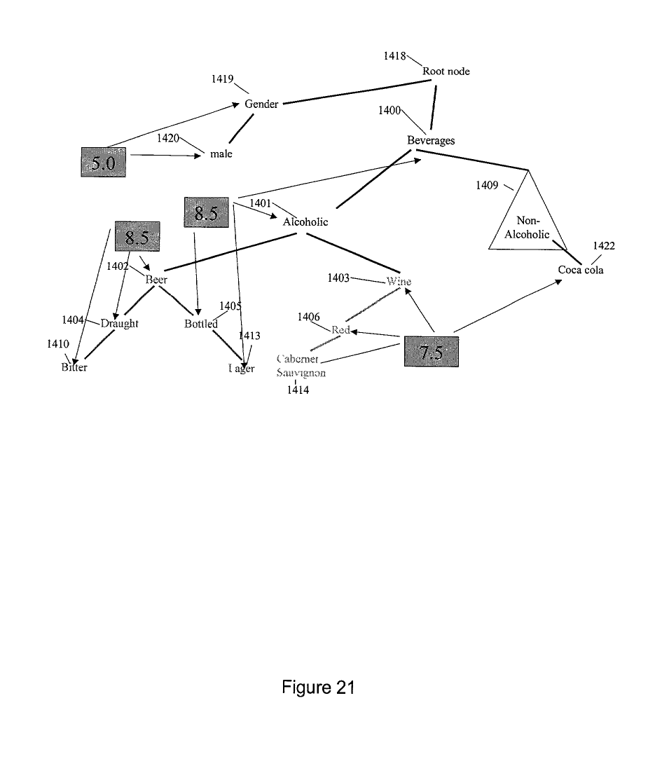

Assume that the result of processing the click stream feedback for user pstirpe is shown in FIG. 20. Furthermore, assume that the information shown in FIG. 20 is contained in a file named pstirpe_cs, referenced in the knowledge warehouse table illustrated in FIG. 12. Thus, the nodes 1410 and 1412 are weighted with higher weight of 8.5. Now, if the PIG is recomputed, as the new information becomes available or based on some other trigger (e.g. the next time the user logs into the system), the re-computation may incorporate the click stream implicit data resulting in the following PIG shown in FIG. 21. The results show that the interest in the Beer sub-ontology is of higher weighting than the interest in other beverages such as wine, or non-alcoholic beverages. In the earlier PIG computation for user pstirpe (shown in FIG. 18), the user would have been shown content related to Beer, Wine, non-alcoholic beverages with equal preference. As a result of the user's click stream activity, the user now may be shown more content related to Beer rather than content related to wine. Although a strong preference is not demonstrated in the example, the illustration shows how click stream can alter the resulting PIG. Over time, the PIG can become more precise, significantly improving the precision of personalization provided to the user.

Next the new PIG result and resulting level of personalization based on the user additionally providing explicit feedback is illustrated. Explicit feedback can be provided by the user via the user's interface to the present system. For example, in the case of the beverages web site, the user may be provided with the opportunity to explicitly specify their interests during site registration, or at any time. The interface that is offered to the user should ultimately guide the user such that the present system can map the explicit user choices to nodes (labels) in the ontology. Furthermore, the user may explicitly weight their interests in the various concepts. For example, the user interface could provide the user with a hierarchical representation of the ontology, or some subset of the ontology, and ask the user to weight those selected concepts on a scale from 1 to 10, where 1 is the least important and 10 is the most important concept to the user. The weight can be used as initial weightings in the PIG computation. Thus, the explicit user choices enhance the characteristic data in an ontology centric way. The new explicit characteristic data can be incorporated into the PIG computation, again, with the goal of providing the user with a more precise level of personalization.

Furthermore, the user may at any time, decide to update their explicit information such that they indicate to the system that they are no longer interested in a particular concept, and thus would not like to be personalized with respect to the concept any longer. The system could, in this case, re-compute the PIG taking into account the lower weighting of the concepts selected by the user to be of less or no explicit importance. The present system may remove the concepts for the user's explicit data in the knowledge warehouse, or may simply apply a significantly lower weighting to the concepts.

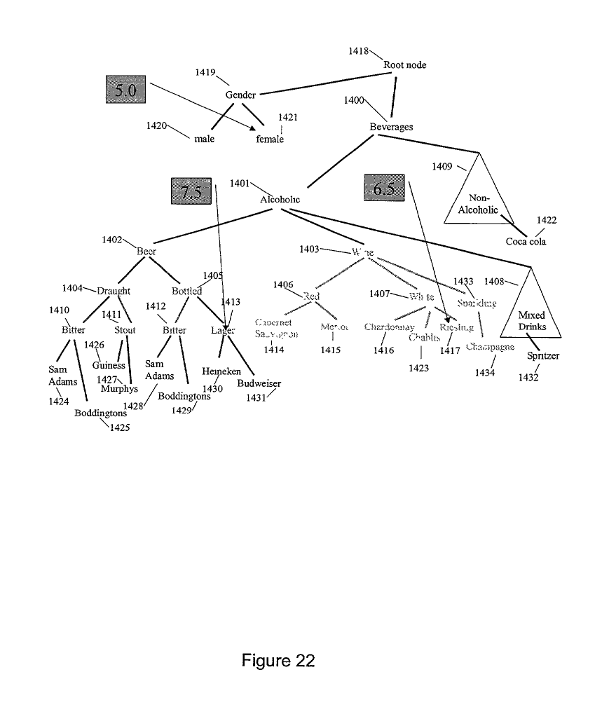

To illustrate the effect of explicit user feedback on the PIG results, an example is provided using the user Jane Doe (userid jdoe), whose source data is provided in FIG. 13. First, the PIG is computed without explicit user data, for illustration purposes. Then, explicit user feedback is illustrated. Based on the source data for the female user jdoe, the initial input working ontology with marked node weights is shown in FIG. 22. The PIG computation is then carried-out and may proceed as follows:

1. Rule 5 repeatedly fires, causing nodes 1407 (White) to be added to the PIG and assigned weight of 6.5, node 1403 (Wine) to be added to the PIG and assigned weight 6.5, node 1405 (Bottled) to be added to the PIG and assigned weight 7.5, node 1402 (Beer) to be added to the PIG and assigned weight 7.5, node 1401 to be added to the PIG and assigned weight 7.5 (maximum of weighting on nodes 1402 and 1403), node 1419 added to the PIG and assigned weight 5.0.

2. Rule 3 fires causing node 1422 (Coca Cola) to be added to the PIG. 3. Rule 5 repeatedly fires, causing node 1422 (Coca Cola) to be assigned weight 7.5 (maximum of nodes 1417 and 1413, repeatedly adding nodes in the 1409 sub-ontology and weighting them appropriately, until node 1400 is added to the PIG, assigned weight 7.5 (maximum of nodes 1401, and the weight brought up from sub-ontology 1409.

4. Rule 4 fires, causing node 1434 (Champagne) to be added to the PIG, assigned weight 7.5

5. Rule 5 repeatedly fires, causing node 1434 to be assigned weight 7.5 (maximum of nodes 1422, 1421, 1403, which then causes the weight of the predecessor nodes 1433, 1407, 1403 to be assigned weight 7.5.

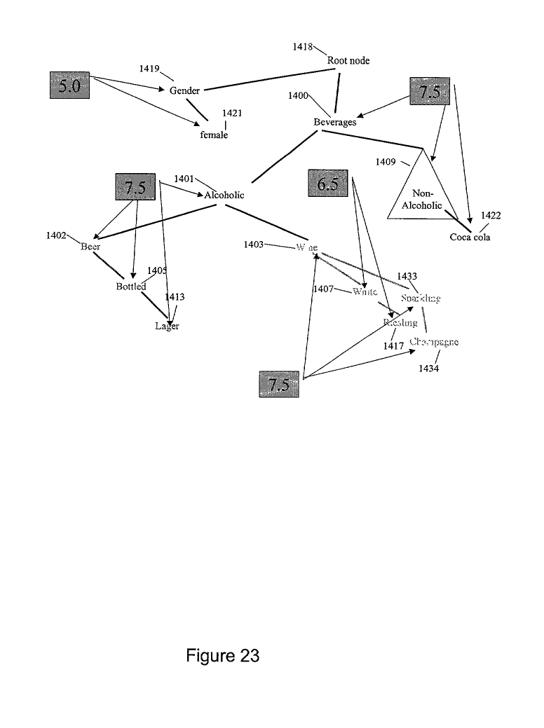

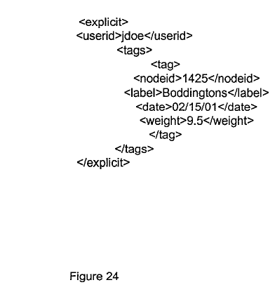

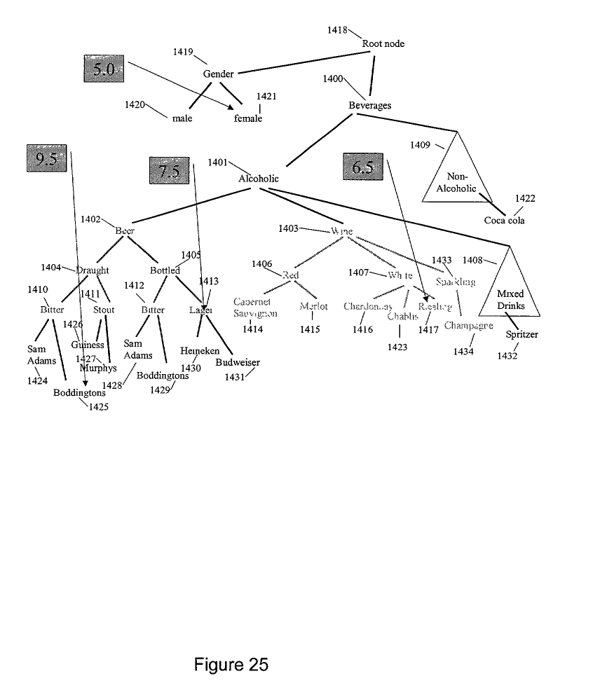

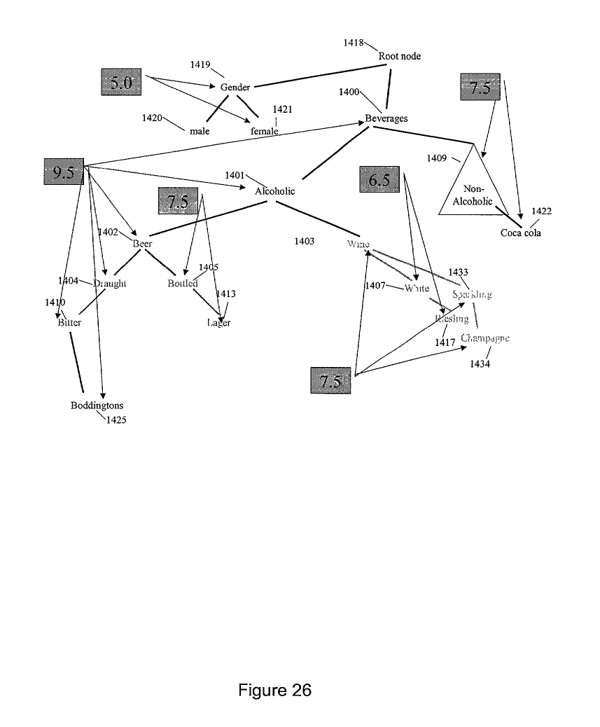

The resulting PIG that does not include implicit or explicit characteristic data (only source data) is illustrated in FIG. 23. The PIG is now recomputed to incorporate explicit user characteristic data. For example, assume that via the beverages web site user interface, the user jdoe, specifies a strong preference for Boddingtons beer. The web site interprets this user action by adding the node 1425 with a weighting of 9.5 to the user's explicit characteristic data file jdoe_e, as listed in the knowledge warehouse table shown in FIG. 12. The explicit data contained in the file jdoe_e may be in the XML form as shown in FIG. 24 and the initial working ontology with marked nodes is illustrated in FIG. 25. The characteristic data is submitted to the inferencing engine, as shown earlier (the inferencing steps are not shown in this example, as the process has already been illustrated several times), and the resulting PIG is computed, illustrated in FIG. 26. The PIG shows a strong preference for the Beer sub-ontology, in particular Boddingtons, Bitter, Draft beer.

As shown in FIG. 16, the results of the PIG may be stored in the knowledge warehouse for future reference. Additionally, or instead of storing the PIG, the personalized information in the PIG may be used to immediately provide the user with personalized information. For example, if the PIG computation was triggered as a result of a user logging onto the present system, then the personalized results could be immediately displayed to the user.

Once the PIG has been computed, the user's profile may be further processed to provide the deep personalization. For example, if the user has logged into the present system, and a PIG and resulting profile becomes available in real-time, the profile may be provided to the Search Engine/Indices Mapper component to lookup and retrieve the corresponding content from the content store.

Search engines for the World Wide Web typically operate by crawling the Internet, retrieving pages and storing them in a local store. Then, the pages are examined for tags, words, or content so that they may be categorized and placed in a large index. Typically, the index is a dictionary of words that may be found in the web pages, ordered in alphabetical order. For each term found on a web page that has been crawled, the page is weighted for that term and referenced from the index. Again, the papers by Page and Brin, and Kleinberg, referenced earlier, specify how search engines operate. Additionally, the following URL may be used to learn more about how search engines operate

The Search Engine and Indices component provided in the present system may use the standard search engine technology described above. However, the standard search engine capabilities may be enhanced as follows:

A web crawler may crawl through the content store. Since the content store consists of content that has been tagged against the reference ontology, the search engine would use the keywords to index the content. Since the tags associated with each content item may also be weighted, the search engine may simply use the provided weighting of the content to include in the indices. Thus, the index may consist of a dictionary of labels (as found in the ontology). The difference between standard web crawling and the Search Engine and Indices component in the present system is that the later is crawling a content store that is tagged with weights. Thus, the index that is constructed provides more precise mapping between the labels in the user's profile or PIG and the actual content that is relevant. Since the content is tagged against the same reference ontology as the PIG is computed, the mapping of PIG labels to content store content is significantly more precise than standard search engine results. Again, this precision capability is possible because the reference ontology is made central to most components in the present system.

For example, using the PIG results illustrated in FIG. 23 for user jdoe, and the example content illustrated in FIG. 14 and FIG. 15, the Search Engine and Indices component may provide all of the content, including the ads and news stories as potential content to be shown to the user. Note that either ad may be rendered to the user because the user's PIG indicates an interest in nodes 1422 (Coca Cola) and 1434 (Champagne) with equal weight of 7.5. However, since the White's Champagne is weighted itself with a higher weight 6 than the Coca Cola ad 5, the White's Champagne ad may be shown first.

With respect to the news stories, the order in which the stories may be rendered to the user could be:

1. Is there Life after White Wine?

2. Best Champagnes of Napa Valley

Since the story “Is there Life after White Wine” is tagged with node 1434 with a higher weight of 7, than the weight of the same node associated with the other story, story “Is there Life after White Wine” will be recommended to be shown first.

Once the content as been selected, and references have been retrieved from the content store in a prioritized order, it is provided to the Presentation rules store 1302 and Inferencing Engine 1301, illustrated in FIG. 10. This engine may execute a different set of rules on the resulting set of content to determine what content should be shown first, in what sections of the web page, for example. These components may reprioritize the content that is displayed to the user based on short-term business rules, time-of-day rules, screen real estate issues or other factors.

For example, the Presentation rules may contain a business rule that states for the next three days, always show Coca Cola advertisements rather than any Champagne ads because the Coca Cola company is sponsoring the Olympics games which terminates in three days. It is hypothetically also known that Coca Cola does more sales during the Olympics than any other time of the year. Finally, the Coca Cola Company has paid the beverages web service company bushels of money to run the advertisements at top priority. This is an example of how the Presentation rules may alter the personalization results for business purposes. Such rules may be put into place in the present system. Thus, while a system may be enabled to provide precise personalization, such personalization may temporarily be over ridden or augmented for business or other purposes.

The present system can support the concept of communities, as exists today in contemporary systems. Additionally, however, the present system provides greater capabilities than existing systems mainly as a result of having the reference ontology as the central conceptual reference for most aspects of the system. More specifically, communities may be defined and represented as extensions of the reference ontology and thus with respect to the ontology. That is, a community may be represented as a new node in the ontology, and thus reap all of the benefits provided by being represented as a concept in the ontology, For example, user's may be guided to be added to existing communities by the rules contained in the rules store. Again, it is assumed that an expert would create such rules that cause users or request users to be added to a community. Content may be tagged against the new concept node in the ontology, enabling the content to be made available to all users in the community.

New communities can come about in many ways. New communities can be discovered by running analytical computations against the population of user profiles in the knowledge warehouse, to extract common concepts that are of interest to the subset user population. Domain experts, business managers, or any one can simply decide to create various communities and extend the ontology appropriately. Users can suggest that new communities be made available by the present system, thus providing explicit interest in such communities. The creation of communities should be carried-out with care so as not to conflict with the spirit of the concepts represented by the ontology. Thus, it is envisioned that such ontology extensions will usually be carried-out via a careful process involving many parties.

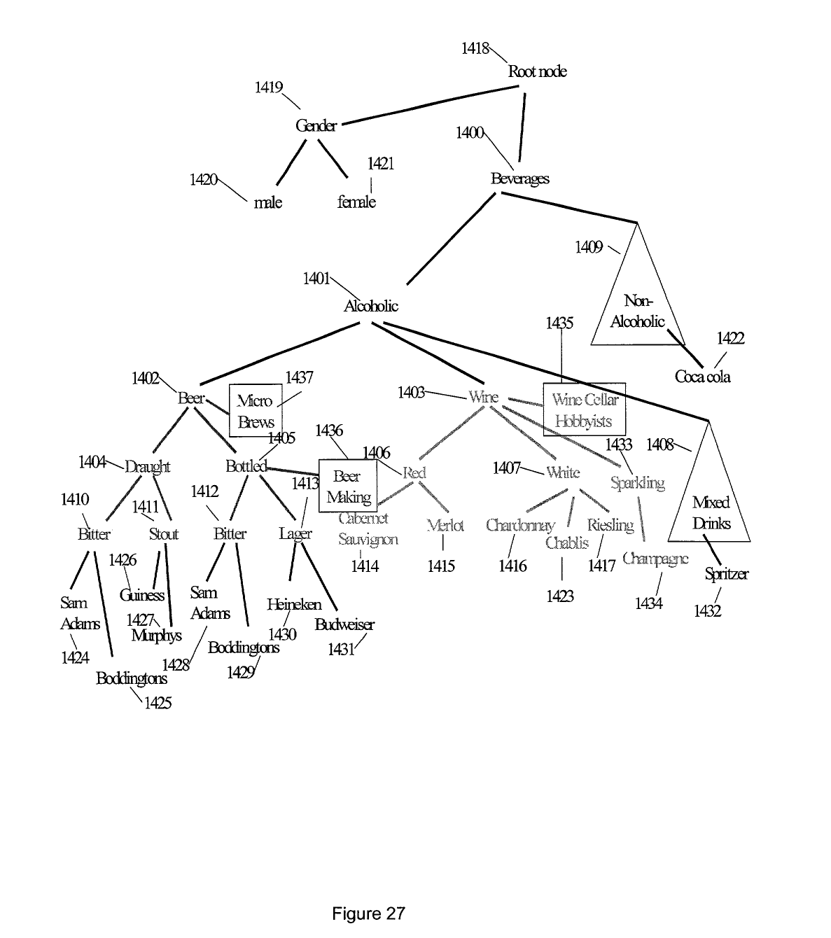

The community capabilities are now illustrated in the beverages enabled present system. Assume that some analytical computations have been run on the knowledge warehouse and it has been determined that there are several large groups of people existing in the knowledge warehouse and that several communities should be formed to group the users of common interest. As a result, the ontology is extended to include the Wine Cellar Hobbyists, Beer Making, and Micro Brew community nodes as shown in FIG. 27. Content that is already in the content store may be re-examined to determine if the content should be re-tagged against any of the new community nodes, or the tags should be updated. Furthermore, all new content that may be entered into the content management's workflow process may be tagged with the new community concept nodes now contained in the reference ontology.

Furthermore, assume that the beverages expert has determined that 85% of beverage users that strongly like wine and are male also maintain private wine cellars. Furthermore, 90% of people that are strongly interested in bottled beer and are male enjoy beer making at home. As a result, the following rules are developed.

Isa1420 AND likes1403 then IsIn1435 (rule 6)

which means that if the user is male and likes wine, then the user should be in the community Wine Cellar Hobbyist community.

Isa1420 AND likes1406 then isIn1436 (rule 7)

Which means that if the user is male and likes bottled beer, then they should be placed in the Beer Making community. A PIG computation may proceed as previously illustrated in earlier examples. When a PIG is computed for a user, the user may be placed or given the opportunity to be placed in a corresponding community, based on the results in the PIG. The content, opportunities, information provided to the community, may then be made available to the users that have recently been added to the community.

This simple example shows how the present system can provide communities or collaborative filtering capabilities. More sophisticated examples can be developed that allow users to be added to, or given the opportunity to be added to very diverse communities. Since the present system may operate at layer 5, with respect to FIG. 1, the present system does not constrain or pigeon hole the user into a specific community or set of communities, without possibility of breaking out of the community. The present system may, at any time, take into account new information and re-compute the PIG, thus quickly reacting to life changing events, for example, to produce precise, personalized user experience. Furthermore, the present system can make use of the knowledge about users who are involved in multiple communities to infer new information. That is, the domain expert can create rules in the rules store that take into account the new community nodes in the ontology and infer new information from those community concepts.

As stated earlier, the invention includes a method by which the content in the content store may be enriched. The method used to carryout this process is essentially similar to the PIG computation method. First, the initial starting data is, however, not user specific characteristic data, but the tags associated with the content item, with their corresponding weights. Note that the initial set of tags is typically obtained as output of the content management workflow process, where each content item is tagged against the ontology to get a set of tags and corresponding weights. The tags may be represented as a list of tags, or as a graph, which is a derived graph from the reference ontology. For the purposes of the content enrichment process via inferencing, let us call this graph the initial content item graph. The advantage of storing the content item tags in the form of an initial content item graph is that the relationship between the tags associated with the content item is maintained in the graph, whereas if the tags are represented as a set or list, the relationship amongst the tags in the set is not represented or captured.

The tags (corresponding to nodes in the working copy of the ontology) or initial content item graph and their weights are assigned to the corresponding nodes in the working copy of the ontology. Next the rules engine is applied against the working copy of the ontology, until a fixed point is reached, such that content interest graph (CIG) is created. As new tags are added to the CIG, the tags associated with the content become more enriched. When the fixed point is reached, the CIG may be stored or associated with the content item being processed. This process can be carried-out for each content item in the content store. As new rules are added to the system, or changed, the CIG computation may be recomputed for each content item, at the discretion of the present system operators and managers.

As stated earlier, the present system may be used to provide expert guidance to users, while simultaneously referencing the rules store and potentially the user's characteristic data during the workflow or decision-making process. The application of the invention is integrating workflow or decision processes with the present system that could exploit the expert system capabilities and potentially user characteristic data, to provide more precise personalized decisions and workflows processes. For example, a user of the present system enabled beverages web service may initially arrive at the web site, with some characteristic data. The web site may provide a workflow application that helps the user more precisely personalize himself with respect to the service. Thus, the web site may provide a workflow process that helps the user decide what beverages they have interest in and thus what information, purchasing offers, or community information they would like to see. For example, a user may arrive at the beverage web site, where they are prompted with a question asking what beverages do they like. If the user does not login or identify itself to the system, then no characteristic data may be available to the present system and the expert workflow process. If the user does identify itself to the system, then the present system may also exploit characteristic data during the workflow process.

Assume the user has logged-in for the first time, and his characteristic data indicates that he is male 1420 with weight 5, and has a strong like for Cabernet Sauvignon 1414 with weight 8. The application may ask the user what beverages he is interested in, and the user may indicate that he has a strong interested in Sam Adams. The workflow system may thus assigned nodes 1424 and 1428 with weight 7.5 to the user characteristic data, of the explicit type. The characteristic data may then be used as input to the PIG computation, where resulting in the rule 1 may fire suggesting that the user try Cabernet Sauvignon 1414. The workflow system may then ask the user if they are interested in trying Cabernet Sauvignon wine.

The expert guided workflow application may guide the user through the decision making process, by requesting that the user make explicit choices, and after each choice or some set of choices has been made, potentially re-computing the PIG to infer any new possibilities or information. The process can continue until the user has found what they are interested in, joined any appropriate communities of interest, or simply no longer wants to participate in the expertly guided workflow process.

The system described above includes a variety of embodiments. Other embodiments are considered within the scope of the invention. The invention is known through the following claims.

We claim:

1. A system for providing personalized content to a user, comprising:
a data warehouse that stores user data corresponding to a user;
an ontology;
an inferencing engine that generates consequences based on information in said data warehouse, wherein said user data is tagged in accordance with said ontology.

2. The system of claim 1, wherein the data warehouse contains healthcare data.

3. The system of claim 1, wherein the data warehouse contains human resource data.

4. The system of claim 1, wherein the data warehouse contains financial data.

5. The system of claim 1, further comprising:
a content store,
wherein content information from said content store is tagged in accordance with said ontology.

6. The system of claim 1, wherein said inferencing engine generates and outputs a personal interest graph (PIG) created for the user based on data rules.

7. The system of claim 5, wherein said inferencing engine generates and outputs a personal interest graph (PIG) created for the user based on data rules,
said system further comprising:
a display for displaying selective information from said content store based at least in part on the PIG.

8. The system of claim 1, wherein the inferencing engine generates and outputs a list of weighted nodes.

9. The system of claim 5, said display providing a personalized view of said content for said user.

10. The system of claim 5, said display providing a personalized view of said content regarding said user for a third party.

11. The system of claim 1, wherein said user data includes click stream data.

12. The system of claim 1, wherein said user data includes source data.

13. The system of claim 1, wherein said user data includes explicit data.

14. The system of claim 1, wherein said user data includes implicit data.

15. The system of claim 1, further comprising a third party user obtaining a personalized view of said user, wherein the third party user is displayed information relating at least in part to said user's personalized view.

16. The system of claim 15, wherein the third party provides information to said user related to said displayed information.

17. The system of claim 15, wherein the third party provides information regarding said user to another, other than said user.

18. The system of claim 1, further comprising:
a data mart that receives tagged user data and an analytics console that analyzes said tagged user data in at least one of said data mart and said data warehouse.

19. A method for drawing conclusions for personalized content relating to a user, comprising the steps of:
receiving user data corresponding to a user;
tagging said user data in accordance with an ontology; and
drawing conclusions over at least said tagged user data.

20. The method of claim 19, wherein said drawing conclusions step is performed by at least one inferencing engine.

21. The method of claim 19, wherein said receiving user data step includes receiving healthcare data related to said user.

22. The method of claim 19, wherein said receiving user data step includes receiving human resource data related to said user.

23. The method of claim 19, wherein said receiving user data step includes receiving financial data related to said user.

24. The method of claim 19, further comprising the step of:
generating a personal interest graph (PIG) regarding a user based on data rules.

25. The method of claim 19, further comprising the steps of:
generating and outputting a list of weighted nodes.

26. The method of claim 19, further comprising the step of:
displaying said conclusions to said user.

27. The method of claim 19, further comprising the step of:
displaying said conclusions to a third party.

28. The method of claim 19, further comprising the steps of:
receiving content;
tagging said content in accordance with said ontology.

29. The method of claim 19, further comprising the step of:
enhancing said user data with at least one of click stream data, source data, explicit data, and implicit data.

30. The method of claim 19, further comprising the steps of:
separately storing said tagged user data in a data mart, and
analyzing said separately stored tagged user data.

31. A system for drawing conclusions for personalized content relating to a user, comprising:
means for receiving user data corresponding to a user;
means for tagging said user data in accordance with an ontology; and
means for drawing conclusions over at least said tagged user data.

32. The system of claim 31, wherein said means for drawing conclusions further comprises:
means for drawing inferences.

33. The system of claim 31, further comprising:
means for generating a personal interest graph (PIG) regarding a user based on data rules.

34. The system of claim 31, further comprising:
means for generating outputting a list of weighted nodes.

35. The system of claim 31, further comprising:
means for displaying said conclusions to said user.

36. The system of claim 31, further comprising:
means for displaying said conclusions to a third party.

37. The system of claim 31, further comprising:
means for receiving content;
means for tagging said content in accordance with said ontology.

38. The system of claim 31, further comprising:
means for enhancing said user data with at least one of click stream data, source data, explicit data, and implicit data.

39. The method of claim 31, further comprising:
means for separately storing said tagged user data in a data mart, and
means for analyzing said separately stored tagged user data.

40. A computer-readable medium for storing a program, said program for drawing conclusions for personalized content relating to a user, said program having the steps of:
receiving user data corresponding to a user;
tagging said user data in accordance with an ontology; and
drawing conclusions over at least said tagged user data.

41. A computer-readable medium for storing a data structure, said data structure comprising:
a first portion storing user data tagged in accordance with an ontology;
a second portion storing a weighting value associated with said user data.

42. The computer-readable medium according to claim 41, said second portion being part of a list of weighted nodes.

43. The computer-readable medium according to claim 41, said data structure forming a personalized interest graph.

44. The system according to claim 1, wherein said user is de-identified in said data warehouse.

45. The method according to claim 19, said receiving step further comprising the steps of:
receiving user data relating to a de-identified user; and,
authenticating said de-identified user.

46. The system according to claim 31, further comprising:
means for receiving user data relating to a de-identified user; and,
means for authenticating said de-identified user.

47. A system for providing tagged content comprising:
a content store that stores content information;
an ontology;
a first inferencing engine that generates consequences based on information in said content store, wherein said content information is tagged in accordance with said ontology.

48. The system of claim 47, wherein said consequences are a weighted list.

49. The system of claim 47, wherein said consequences are a content information graph.

50. The system according to claim 47, further comprising:
a data warehouse that stores tagged user data; and
a second inferencing engine that generates consequences based on said tagged user data.

51. The system according to claim 50, further comprising:
a comparator that compares the consequences of from said first inferencing engine with the consequences from said second inferencing engine.

52. A method for drawing conclusions for content comprising the steps of:
receiving content information;
tagging said content information in accordance with an ontology; and
drawing first conclusions over at least said tagged content information.

53. The method according to claim 52, further comprising the steps of:
storing tagged user data in a data warehouse; and
drawing second conclusions over at least said tagged user data.

54. The method according to claim 53, further comprising the step of:
comparing the consequences of from said drawing first conclusions step with the consequences of said second conclusions step.

55. The method according to claim 52, wherein said first conclusions are a weighted list.

56. The method according to claim 52, wherein said first conclusions are a content information graph.

57. A system for drawing conclusions for content comprising:
means for receiving content information;
means for tagging said content information in accordance with an ontology; and
means for drawing first conclusions over at least said tagged content information.

58. The system according to claim 57, further comprising:
means for storing tagged user data in a data warehouse; and
means for drawing second conclusions over at least said tagged user data.

59. The system according to claim 58, further comprising:
means for comparing the consequences of from said means for drawing said first conclusions with the consequences of said means for drawing said second conclusions.
